(19) United States
(12) Patent Application Publication
(10) Pub. No.: US 2025/0287316 A1
(43) Pub. Date: Sep. 11, 2025

(54) POWER SCALING AND SPLITTING FOR UPLINK HIGH RESOLUTION TPMI

(71) Applicant: QUALCOMM INCORPORATED, San Diego, CA (US)

(72) Inventors: Chenxi Hao, Beijing (CN); Yi Huang, San Diego, CA (US); Yu Zhang, San Diego, CA (US); Liangming Wu, Beijing (CN); Chao Wei, Beijing (CN); Hao Xu, Beijing (CN); Peter Gaal, San Diego, CA (US)

(21) Appl. No.: 18/863,614

(22) PCT Filed: Jun. 23, 2022
(86) PCT No.: PCT/CN2022/100655

§ 371 Date: Nov. 6, 2024

(51) Int. Cl. H04W 52/14; H04W 52/36

(52) U.S. Cl. CPC H04W 52/146; H04W 52/365

(57) ABSTRACT

Methods, systems, and devices for wireless communications are described. A user equipment (UE), or some other network node, may scale uplink shared channel transmit power based on a received high-resolution transmitted precoding matrix indicator (TPMI) from a network node. For example, the UE may calculate a ratio for one or more antenna ports of the UE based on coefficient amplitudes from the TPMI, and may determine the scaling factor based on a comparison between the ratio and a threshold. The described techniques may also enable the UE to split power for the one or more antenna ports of the UE based on the received high-resolution TPMI. For example, the UE may calculate a ratio for each antenna port based on coefficient amplitudes from the TPMI, and may determine how power is to be split across antenna ports based on a comparison between the ratio and a threshold.

### CROSS REFERENCE

The present application is a 371 national stage filing of International PCT Application No. PCT/CN2022/100655 by Hao et al. entitled “POWER SCALING AND SPLITTING FOR UPLINK HIGH RESOLUTION TPMI,” filed Jun. 23, 2022, which is assigned to the assignee hereof, and which is expressly incorporated by reference in its entirety herein.

### INTRODUCTION

The following relates to wireless communications, including power scaling and splitting for transmissions. Wireless communications systems are widely deployed to provide various types of communication content such as voice, video, packet data, messaging, broadcast, and so on. These systems may be capable of supporting communication with multiple users by sharing the available system resources (e.g., time, frequency, and power). Aspects of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support power scaling and splitting for uplink high resolution transmitted precoding matrix indicator (TPMI). For example, the described techniques may enable a user equipment (UE), or some other network node to scale uplink shared channel transmit power based on a received high-resolution TPMI from a network node. For example, the UE may calculate a ratio for one or more antenna ports of the UE based on coefficient amplitudes from the TPMI, and may determine the scaling factor based on a comparison between the ratio and a threshold. The described techniques may also enable the UE to split power for the one or more antenna ports of the UE based on the received high-resolution TPMI. For example, the UE may calculate a ratio for each antenna port based on coefficient amplitudes from the TPMI, and may determine how power is to be split across antenna ports based on a comparison between the ratio and a threshold. By scaling power and splitting power for uplink shared channel transmission, the UE may be able to correctly allocate power to antenna ports for transmission when the UE receives high-resolution TPMIs.

A method for wireless communication at a first network node is described. The method may include receiving, from a second network node, information indicative of a precoder to be applied to an uplink shared channel transmission, modifying a first transmission power resulting in a second transmission power, where the first transmission power is for transmission of the uplink shared channel transmission, and where the first network node modifies the first transmission power based on one or more coefficients associated with the precoder, and transmitting, to the second network node, the uplink shared channel transmission using one or more antenna ports in accordance with the second transmission power.

A first network node for wireless communications (e.g., an apparatus for wireless communication at a first network node) is described. The first network node may include a memory, and at least one processor coupled to the memory. The at least one processor may be configured to receive, from a second network node, information indicative of a precoder to be applied to an uplink shared channel transmission, modify a first transmission power resulting in a second transmission power, where the first transmission power is for transmission of the uplink shared channel transmission, and where, to modify the first transmission power, the at least one processor is configured to modify the first transmission power based on one or more coefficients associated with the precoder, and transmit, to the second network node, the uplink shared channel transmission using one or more antenna ports in accordance with the second transmission power.

Another apparatus for wireless communication at a first network node is described. The apparatus may include means for receiving, from a second network node, information indicative of a precoder to be applied to an uplink shared channel transmission, means for modifying a first transmission power resulting in a second transmission power, where the first transmission power is for transmission of the uplink shared channel transmission, and where the first network node modifies the first transmission power based on one or more coefficients associated with the precoder, and means for transmitting, to the second network node, the uplink shared channel transmission using one or more antenna ports in accordance with the second transmission power.

A non-transitory computer-readable medium having code for wireless communication at a first network node is described. The code, when executed by the first network node, causes the first network node to receive, from a second network node, information indicative of a precoder to be applied to an uplink shared channel transmission, modify a first transmission power resulting in a second transmission power, where the first transmission power is for transmission of the uplink shared channel transmission, and where the first network node modifies the first transmission power based on one or more coefficients associated with the precoder, and transmit, to the second network node, the uplink shared channel transmission using one or more antenna ports in accordance with the second transmission power.

In some aspects of the method, apparatuses, and non-transitory computer-readable medium described herein, modifying the first transmission power may include operations, features, means, or instructions for scaling the first transmission power by a power scaling factor resulting in the second transmission power, where the power scaling factor may be based on one or more coefficients associated with the precoder and splitting the second transmission power across one or more antenna ports.

In some aspects of the method, apparatuses, and non-transitory computer-readable medium described herein, the power scaling factor may be based on a comparison of a ratio to a threshold and the ratio corresponds to one of the one or more coefficients divided by a sum of the one or more coefficients.

In some aspects of the method, apparatuses, and non-transitory computer-readable medium described herein, the power scaling factor may be based on power headroom information corresponding to an amount of available transmission power.

In some aspects of the method, apparatuses, and non-transitory computer-readable medium described herein, the power headroom information includes respective power headroom information for each respective antenna port of the one or more antenna ports.

In some aspects of the method, apparatuses, and non-transitory computer-readable medium described herein, the power scaling factor may be a first value if the ratio may be less than or equal to the threshold, or a second value if the ratio may be greater than or equal to the threshold.

In some aspects of the method, apparatuses, and non-transitory computer-readable medium described herein, each antenna port of the one or more antenna ports corresponds to a respective port-specific threshold.

In some aspects of the method, apparatuses, and non-transitory computer-readable medium described herein, the threshold corresponds to each antenna port of one or more antenna ports.

Some aspects of the method, apparatuses, and non-transitory computer-readable medium described herein may further include operations, features, means, or instructions for transmitting, to the second network node, information indicative of the threshold.

In some aspects of the method, apparatuses, and non-transitory computer-readable medium described herein, splitting the second transmission power across the one or more antenna ports may include operations, features, means, or instructions for splitting the second transmission power based on the ratio.

Some aspects of the method, apparatuses, and non-transitory computer-readable medium described herein may further include operations, features, means, or instructions for transmitting a message indicative of a respective threshold for each port of the one or more antenna ports, where the power scaling factor may be based on a comparison of a ratio to one or more of the respective thresholds, and where the ratio corresponds to one of the one or more coefficients divided by a sum of the one or more coefficient.

In some aspects of the method, apparatuses, and non-transitory computer-readable medium described herein, modifying the first transmission power may include operations, features, means, or instructions for scaling the first transmission power by a power scaling factor resulting in a second transmission power and splitting the second transmission power across one or more antenna ports based on one or more coefficients associated with the precoder.

In some aspects of the method, apparatuses, and non-transitory computer-readable medium described herein, splitting the second transmission power may include operations, features, means, or instructions for determining one or more power ratios corresponding to each of the one or more antenna ports based on the one or more coefficients associated with precoder, where a first portion of the one or more antenna ports that correspond to power ratios exceeding a threshold include a first set of antenna ports, and a second portion of the one or more antenna ports that correspond to power ratios not exceeding the threshold include a second set of antenna ports.

In some aspects of the method, apparatuses, and non-transitory computer-readable medium described herein, splitting the second transmission power may include operations, features, means, or instructions for setting respective power ratios for the first set of antenna ports equal to the threshold based on the power ratios exceeding the threshold prior to being set equal to the threshold and allocating the second transmission power across the first set of antenna ports and the second set of antenna ports based on the one or more power ratios.

In some aspects of the method, apparatuses, and non-transitory computer-readable medium described herein, determining the one or more power ratios may include operations, features, means, or instructions for determining the one or more power ratios, where for each of the one or more antenna ports, the one or more power ratios across one or more transmission layers may be based on amplitudes of the one or more transmission layers.

In some aspects of the method, apparatuses, and non-transitory computer-readable medium described herein, each antenna port of the one or more antenna ports corresponds to a respective port-specific threshold.

In some aspects of the method, apparatuses, and non-transitory computer-readable medium described herein, the threshold corresponds to each antenna port one or more antenna ports.

Some aspects of the method, apparatuses, and non-transitory computer-readable medium described herein may further include operations, features, means, or instructions for transmitting, to the second network node, information indicative of the threshold.

Some aspects of the method, apparatuses, and non-transitory computer-readable medium described herein may further include operations, features, means, or instructions for transmitting a message indicative of a respective threshold for each port of the one or more antenna ports.

In some aspects of the method, apparatuses, and non-transitory computer-readable medium described herein, splitting the second transmission power may include operations, features, means, or instructions for splitting the second transmission power based on the first transmission power and power headroom information corresponding to an amount of available transmission power.

In some aspects of the method, apparatuses, and non-transitory computer-readable medium described herein, the power headroom information includes respective power headroom information for each respective antenna port of the one or more antenna ports.

In some aspects of the method, apparatuses, and non-transitory computer-readable medium described herein, scaling the first transmission power by the power scaling factor may include operations, features, means, or instructions for scaling the first transmission power by the power scaling factor that may be defined as a quantity of non-zero antenna ports divided by a quantity of sounding reference signal antenna ports.

### BRIEF DESCRIPTION OF THE DRAWINGS

FIG. 1 illustrates an example of a wireless communications system that supports power scaling and splitting for uplink high resolution transmitted precoding matrix indicator (TPMI) in accordance with one or more aspects of the present disclosure.

FIG. 2 illustrates an example of a wireless communications system that supports power scaling and splitting for uplink high resolution TPMI in accordance with one or more aspects of the present disclosure.

FIGS. 3A and 3B illustrate examples of codebook schemes that support power scaling and splitting for uplink high resolution TPMI in accordance with one or more aspects of the present disclosure.

FIG. 4 illustrates an example of a process flow that supports power scaling and splitting for uplink high resolution TPMI in accordance with one or more aspects of the present disclosure.

FIGS. 5 and 6 show block diagrams of devices that support power scaling and splitting for uplink high resolution TPMI in accordance with one or more aspects of the present disclosure.

FIG. 7 shows a block diagram of a communications manager that supports power scaling and splitting for uplink high resolution TPMI in accordance with one or more aspects of the present disclosure.

FIG. 8 shows a diagram of a system including a device that supports power scaling and splitting for uplink high resolution TPMI in accordance with one or more aspects of the present disclosure.

FIGS. 9 through 11 show flowcharts illustrating methods that support power scaling and splitting for uplink high resolution TPMI in accordance with one or more aspects of the present disclosure.

### DETAILED DESCRIPTION

A first network node, such as a user equipment (UE), may transmit an uplink shared channel (e.g., a physical uplink shared channel (PUSCH)) to a second network node (e.g., a base station, network entity). To transmit the uplink shared channel, the UE may first transmit a sounding reference signal (SRS) to the network node, the network node may measure the SRS to determine one or more best resources for the uplink shared channel, the network node may transmit control signaling to the UE that includes a transmitted precoding matrix indicator (TPMI), and the UE may use the TPMI to determine a precoder for allocating uplink transmit power to various antenna ports (e.g., by looking up allocations in a table). The UE may scale (using a power scaling factor) and/or split the uplink transmit power to ensure that the UE is not transmitting more power than power amplifiers (PAs) can handle. However, in some cases, the TPMI may be a high-resolution TPMI (that is, the UE may calculate the precoder rather than looking up the precoder in the table), and thus the allocation of uplink transmit power to the various antenna ports may be more high-resolution (e.g., by more efficiently allocating layers of the transmission that benefit more from increased power allocation compared to other layers). Because the power that is allocated to each antenna port can be any portion of the total transmission power (e.g., due to being more high-resolution), it is important to determine the power scaling factor to scale the uplink transmit power and/or determine a splitting allocation for each antenna port so that, for example, no PA of any antenna port is allocated more power than it can handle.

To scale PUSCH transmit power, the UE may scale the uplink transmit power based on the received high-resolution TPMI. For example, the UE may calculate a ratio for each antenna port based on coefficient amplitudes from the TPMI, and may determine the scaling factor based on a comparison between the ratio and a threshold. To properly split power for each antenna port, the UE may split power for each antenna port based on the received high-resolution TPMI. For example, the UE may calculate a ratio for each antenna port based on coefficient amplitudes from the TPMI, and may determine how power is to be split across antenna ports based on a comparison between the ratio and a threshold. By scaling and splitting power for uplink transmission in either of these ways, the UE may be able to correctly allocate power to antenna ports for transmission when receiving high-resolution TPMIs.

Aspects of the disclosure are initially described in the context of wireless communications systems. Aspects of the disclosure are further illustrated by and described with reference to codebook schemes, process flows, apparatus diagrams, system diagrams, and flowcharts that relate to power scaling and splitting for uplink high resolution TPMI.

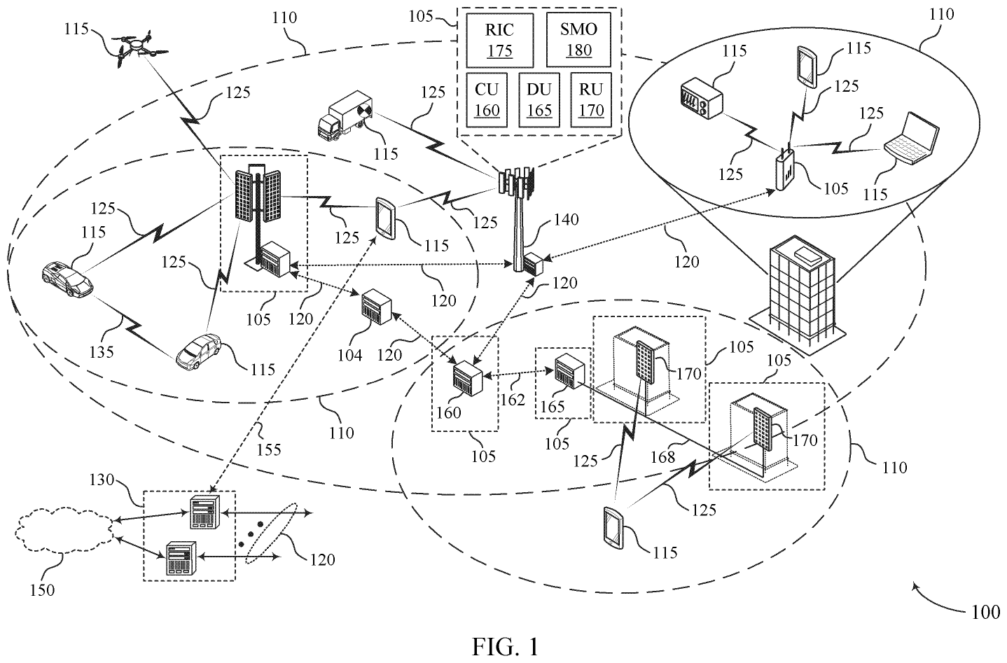

FIG. 1 illustrates an example of a wireless communications system 100 that supports power scaling and splitting for uplink high resolution TPMI in accordance with one or more aspects of the present disclosure. The wireless communications system 100 may include one or more network entities 105, one or more UEs 115, and a core network 130. In some aspects, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various aspects, a network entity 105 may be referred to as a network element, a mobility element, a radio access network (RAN) node, or network equipment, among other nomenclature. In some aspects, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, anode of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some aspects, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some aspects, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some aspects, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some aspects, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some aspects, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some aspects, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some aspects, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some aspects, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support power scaling and splitting for uplink high resolution TPMI as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some aspects, a UE 115 may include or be referred to as a wireless local loop (WLL) station, an Internet of Things (IoT) device, an Internet of Everything (IoE) device, or a machine type communications (MTC) device, among other aspects, which may be implemented in various objects such as appliances, or vehicles, meters, among other aspects.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other aspects, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some aspects, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some aspects, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some aspects, a network entity 105 (e.g., a base station 140, an RU 170) may be movable and therefore provide communication coverage for a moving coverage area 110. In some aspects, different coverage areas 110 associated with different technologies may overlap, but the different coverage areas 110 may be supported by the same network entity 105. In some other aspects, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some aspects, a UE 115 may be configured to support communicating directly with other UEs 115 via a device-to-device (D2D) communication link 135 (e.g., in accordance with a peer-to-peer (P2P), D2D, or sidelink protocol). In some aspects, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some aspects, one or more UEs 115 of such a group may be outside the coverage area 110 of a network entity 105 or may be otherwise unable to or not configured to receive transmissions from a network entity 105. In some aspects, groups of the UEs 115 communicating via D2D communications may support a one-to-many (1:M) system in which each UE 115 transmits to each of the other UEs 115 in the group. In some aspects, a network entity 105 may facilitate the scheduling of resources for D2D communications. In some other aspects, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some aspects, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some aspects, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network node 105 or a UE 115 may use beam sweeping techniques as part of beam forming operations. For example, a network node 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network node 105 multiple times in different directions. For example, the network node 105 may transmit a signal according to different beamforming weight sets associated with different directions of transmission. Transmissions in different beam directions may be used to identify (e.g., by a transmitting device, such as a network node 105, or by a receiving device, such as a UE 115) a beam direction for later transmission or reception by the network node 105.

In some aspects, transmissions by a device (e.g., by a network node 105 or a UE 115) may be performed using multiple beam directions, and the device may use a combination of digital precoding or radio frequency beamforming to generate a combined beam for transmission (e.g., from a network node 105 to a UE 115). The UE 115 may report feedback that indicates precoding weights for one or more beam directions, and the feedback may correspond to a configured number of beams across a system bandwidth or one or more sub-bands. The network node 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a network node 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a network node 105 or a core network 130 supporting radio bearers for user plane data. At the physical layer, transport channels may be mapped to physical channels.

A UE 115 may use a precoder indicated by a network node 105 via a TPMI to configure an uplink shared channel transmission. The UE 115 may scale and split a transmission power for the uplink shared channel based on the TPMI. However, the TPMI may be a high-resolution TPMI (e.g., may indicate coefficients other than 0, 1, −1, j, or −j), and thus such scaling and splitting techniques may be insufficient or inapplicable for transmitting the uplink shared channel.

The described techniques relate to improved techniques, devices, and apparatuses that support power scaling and splitting for an uplink high resolution TPMIs. The described techniques may enable a UE 115 to scale uplink shared channel transmit power based on a received high-resolution TPMI from a network node 105. For example, the UE 115 may calculate a ratio for one or more antenna ports of the UE 115 based on coefficient amplitudes from the TPMI, and may determine the scaling factor based on a comparison between the ratio and a threshold. The described techniques may also enable the UE 115 to split power for the one or more antenna ports of the UE 115 based on the received high-resolution TPMI. For example, the UE 115 may calculate a ratio for each antenna port based on coefficient amplitudes from the TPMI, and may determine how power is to be split across antenna ports based on a comparison between the ratio and a threshold. By scaling power and splitting power for uplink shared channel transmission, the UE 115 may be able to correctly allocate power to antenna ports for transmission when the UE 115 receives high-resolution TPMIs.

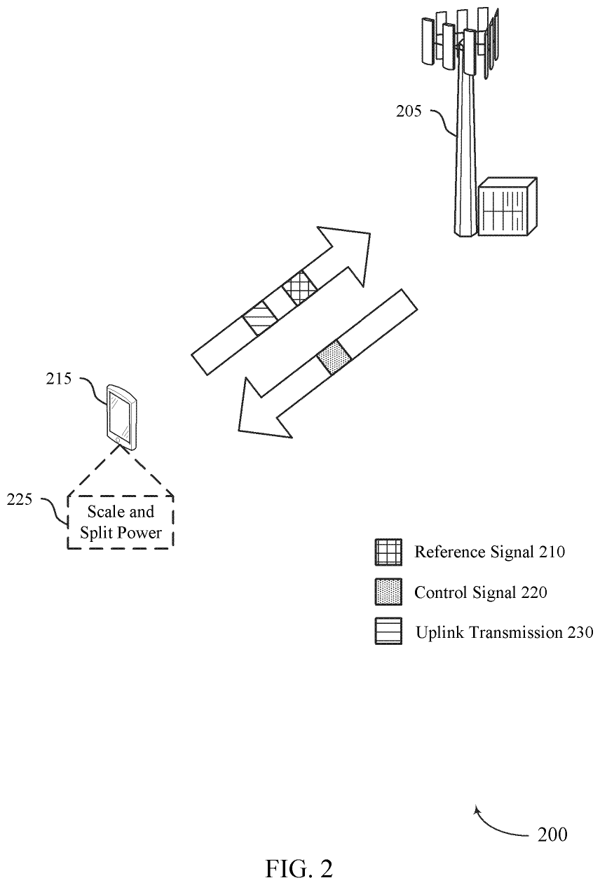

FIG. 2 illustrates an example of a wireless communications system 200 that supports power scaling and splitting for uplink high resolution TPMI in accordance with one or more aspects of the present disclosure. The wireless communications system 200 may implement or be implemented by aspects of the wireless communications system 100 as described with reference to FIG. 1. For example, the wireless communications system 200 may include network node 205 and UE 215, which may be examples of a network node 105 and a UE 115, or any other devices, as described herein. The wireless communications system 200 may support improvements to interference, processing, power consumption, and more efficient utilization of communication resources, among other benefits.

In some wireless communications systems, UE 215 may transmit reference signal 210 (e.g., an SRS) to network node 205 (e.g., a gNB). Network node 205 may determine a precoder (e.g., a wideband precoder) (e.g., W, W2, Wf or the like). Network node 205 may transmit control signal 220 to UE 215 indicating a wideband precoder, an SRS resource, or both, for an uplink data transmission (e.g., uplink transmission 230).

For codebook based uplink transmissions, UE 215 may transmit a non-precoded SRS with up to 2 resources, and each resource may include or correspond to 1, 2 or 4 ports. Network node 205 may measure the SRS, and may select an SRS resource and a wideband precoder (e.g., W) for application to SRS ports within the selected SRS resource. Network node 205 may configure the selected SRS resource, the wideband precoder, or both, to UE 215 via control signal 220 (e.g., network node 205 may transmit one or more control signals 220). For example, network node 205 may configure the selected SRS resource via an SRS resource indicator (SRI), and may configure the wideband precoder via TPMI. For a dynamic grant, network node 205 may configure SRI and TPMI via a downlink control information (DCI) format (e.g., DCI format 0_1). For a configured grant, network node 205 may configure SRI and TPMI via RRC signaling or a DCI message.

For non-codebook based uplink transmissions, UE 215 may transmit precoded SRS with up to 4 resources, and each resource may include or correspond to 1 port. Network node 205 may measure the SRS, and may select one or more SRS resources based on the measurement. Network node 205 may configure the selected one or more SRS resources to UE 215 via control signal 220 (e.g., network node 205 may transmit one or more control signals 220). Network node 205 may configure the selected one or more SRS resources via an SRI. For a dynamic grant, network node 205 may configure SRI via a DCI format (e.g., DCI format 0_1). For a configured grant, network node 205 may configure SRI via radio resource control (RRC) signaling or a DCI message.

For differential-structure codebooks, UE 215 or network node 205 may use wideband precoding, which may correspond to using a wideband TPMI and differential or different amplitudes, phases, or both. UE 215 or network node 205 may additionally or alternatively use frequency selective precoding, which may correspond to using a wideband TPMI, differential or different amplitudes, phases, or both, and frequency domain (FD) bases and associated coefficients.

DCI messages may indicate a precoder (e.g., two-level indication, via 2-stage DCI or single-stage DCI). At a first level (e.g., baseline), a DCI message may indicate a wideband precoder. At a second level, a DCI message may indicate a one or more higher resolution coefficients, FD bases, or both.

At the first level, a DCI message may indicate, use, or correspond to a wideband TPMI (e.g., and may reuse DCI format 0_1). Network node 205 may indicate a wideband precoder and rank (e.g., W_{WB}) which may be used even if a second DCI may be missing. In some cases, a modulation and coding scheme (MCS) may be associated with the wideband precoder (e.g., W_{WB}).

At the second level for wideband high resolution precoding, the second level may correspond to differential power, differential phase, or both, and an MCS may be associated with a wideband precoder (e.g., W). In some cases, the following equation (Equation 1) may apply for W:

$$W = {\underbrace{[ \begin{matrix}1 & 1 \\ j & - j \\ 1 & 1 \\ j & - j\end{matrix} ]}}_{{W}_{WB}} + [ \begin{matrix}{p}_{0 , 0} \cdot {e}^{j {ϕ}_{0 , 0}} {p}_{0 , 1} \cdot {e}^{j {ϕ}_{0 , 1}} \\ {p}_{1 , 0} \cdot {e}^{j {ϕ}_{1 , 0}} {p}_{1 , 1} \cdot {e}^{j {ϕ}_{1 , 1}} \\ {p}_{2 , 0} \cdot {e}^{j {ϕ}_{2 , 0}} {p}_{2 , 1} \cdot {e}^{j {ϕ}_{2 , 1}} \\ {p}_{3 , 0} \cdot {e}^{j {ϕ}_{3 , 0}} {p}_{3 , 1} \cdot {e}^{j {ϕ}_{3 , 1}}\end{matrix} ] \qquad ( 1 )$$

In some aspects, the first column for p may correspond to a first layer (e.g., layer 0), and the second column for p may correspond to a second layer (e.g., layer 1).

At the second level for frequency selective precoding, the second level may correspond to differential power, differential phase, an FD bases indication, or a combination of these, and an MCS may be associated with a wideband precoder (e.g., W). In some cases, the following equation (Equation 2) may apply for W:

$$W = {W}_{WB} ⊗ {1}_{1 \times {N}_{SB}} + {W}_{diff} \qquad ( 2 )$$

In some cases, W_{diff} may be defined by the following equation (Equation 3), corresponding to 1 FD basis per port (e.g., which may be S-CDD like:

$${W}_{diff} = [ \begin{matrix}{p}_{0 , 0} \cdot {e}^{j {ϕ}_{0 , 0}} \cdot {f}_{{m}_{0 , 0}}^{H} & {p}_{0 , 1} \cdot {e}^{j {ϕ}_{0 , 1}} \cdot {f}_{{m}_{0 , 1}}^{H} \\ {p}_{1 , 0} \cdot {e}^{j {ϕ}_{1 , 0}} \cdot {f}_{{m}_{1 , 0}}^{H} & {p}_{1 , 1} \cdot {e}^{j {ϕ}_{1 , 1}} \cdot {f}_{{m}_{1 , 1}}^{H} \\ {p}_{2 , 0} \cdot {e}^{j {ϕ}_{2 , 0}} \cdot {f}_{{m}_{2 , 0}}^{H} & {p}_{2 , 1} \cdot {e}^{j {ϕ}_{2 , 1}} \cdot {f}_{{m}_{2 , 1}}^{H} \\ {p}_{3 , 0} \cdot {e}^{j {ϕ}_{3 , 0}} \cdot {f}_{{m}_{3 , 0}}^{H} & {p}_{3 , 1} \cdot {e}^{j {ϕ}_{3 , 1}} \cdot {f}_{{m}_{3 , 1}}^{H}\end{matrix} ] \qquad ( 3 )$$

In some aspects, the first column of the matrix may correspond to a first layer (e.g., layer 0), and the second column of the matrix may correspond to a second layer (e.g., layer 1).

In some cases, W_{diff} may be defined by the following equation (Equation 4), corresponding to 2 FD basis (e.g., max 2 FD basis) per port per layer:

$${W}_{diff} = [ \begin{matrix}{p}_{0 , 0 , 0} \cdot {e}^{j {ϕ}_{0 , 0 , 0}} \cdot {f}_{{m}_{0 , 0 , 0}}^{H} & {p}_{0 , 0 , 1} \cdot {e}^{j {ϕ}_{0 , 0 , 1}} \cdot {f}_{{m}_{0 , 0 , 1}}^{H} \\ {p}_{1 , 0 , 0} \cdot {e}^{j {ϕ}_{1 , 0 , 0}} \cdot {f}_{{m}_{1 , 0 , 0}}^{H} & {p}_{1 , 0 , 1} \cdot {e}^{j {ϕ}_{1 , 0 , 1}} \cdot {f}_{{m}_{1 , 0 , 1}}^{H} \\ {p}_{2 , 0 , 0} \cdot {e}^{j {ϕ}_{2 , 0 , 0}} \cdot {f}_{{m}_{2 , 0 , 0}}^{H} & {p}_{2 , 0 , 1} \cdot {e}^{j {ϕ}_{2 , 0 , 1}} \cdot {f}_{{m}_{2 , 0 , 1}}^{H} \\ {p}_{3 , 0 , 0} \cdot {e}^{j {ϕ}_{3 , 0 , 0}} \cdot {f}_{{m}_{3 , 0 , 0}}^{H} & {p}_{3 , 0 , 1} \cdot {e}^{j {ϕ}_{3 , 0 , 1}} \cdot {f}_{{m}_{3 , 0 , 1}}^{H}\end{matrix} ] + [ \text{} \begin{matrix}{p}_{0 , 1 , 0} \cdot {e}^{j {ϕ}_{0 , 1 , 0}} \cdot {f}_{{m}_{0 , 1 , 0}}^{H} & {p}_{0 , 1 , 1} \cdot {e}^{j {ϕ}_{0 , 1 , 1}} \cdot {f}_{{m}_{0 , 1 , 1}}^{H} \\ 0 & {p}_{1 , 1 , 1} \cdot {e}^{j {ϕ}_{1 , 1 , 1}} \cdot {f}_{{m}_{1 , 1 , 1}}^{H} \\ 0 & 0 \\ {p}_{3 , 1 , 0} \cdot {e}^{j {ϕ}_{3 , 1 , 0}} \cdot {f}_{{m}_{3 , 1 , 0}}^{H} & 0\end{matrix} ] \qquad ( 4 )$$

Below is an equation (Equation 5) that may give a relation between SRS ports and uplink shared channel (e.g., PUSCH) layers when applying the wideband precoder (e.g., W):

$$[ \begin{matrix}{z}^{( {p}_{0} )} ( i ) \\ ⋮ \\ {z}^{( {p}_{ρ - 1} )} ( i )\end{matrix} ] = W [ \begin{matrix}{y}^{( 0 )} ( i ) \\ ⋮ \\ {y}^{( υ - 1 )} ( i )\end{matrix} ] \qquad ( 5 )$$

z may represent SRS ports in a p-th selected SRS resource (e.g., in a first selected SRS resource for z^{(p}^{₀}⁾(i)), p may represent PUSCH ports via the SRS ports across the selected one or more resources. y may represent various PUSCH layers. For codebook based uplink transmissions, W may represent the wideband precoder, which may map layers to PUSCH ports, and may be drawn from a finite set. For non-codebook based uplink transmissions, W may represent an identity matrix.

Precoder W may be based on a TPMI index. The relationship between TPMI indices and W may be shown in the following tables. Tables 1-7 show precoding matrices for corresponding TPMI indices, and each table may be applicable for various combinations of a number of layers for uplink shared channel transmissions, a number of antenna ports for such transmissions, and whether transform precoding (e.g., precoding based on a transform operation, such as a Fourier transform) is enabled (e.g., at a UE, at a network node):

TABLE 1
Precoding Matrix W For Single-Layer Transmission
Using Two Antenna Ports

| TPMI | W | | | | | | | |
|---|---|---|---|---|---|---|---|---|
| index | (ordered from left to right in increasing order of TPMI index) | | | | | | | |
| 0-5 | $\frac{1}{\sqrt{2}} [ \begin{matrix}1 \\ 0\end{matrix} ]$ | $\frac{1}{\sqrt{2}} [ \begin{matrix}0 \\ 1\end{matrix} ]$ | $\frac{1}{\sqrt{2}} [ \begin{matrix}1 \\ 1\end{matrix} ]$ | $\frac{1}{\sqrt{2}} [ \begin{matrix}1 \\ - 1\end{matrix} ]$ | $\frac{1}{\sqrt{2}} [ \begin{matrix}1 \\ j\end{matrix} ]$ | $\frac{1}{\sqrt{2}} [ \begin{matrix}1 \\ - j\end{matrix} ]$ | — | — |

TABLE 2
Precoding Matrix W For Single-Layer Transmission Using Four Antenna
Ports With Transform Precoding Enabled

| TPMI | W | | | | | | | |
|---|---|---|---|---|---|---|---|---|
| index | (ordered from left to right in increasing order of TPMI index) | | | | | | | |
| 0-7 | $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ | $\frac{1}{2} [ \begin{matrix}1 \\ 0 \\ 1 \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |
| 8-15 | $\frac{1}{2} [ \begin{matrix}0 \\ 1 \\ 0 \\ 1\end{matrix} ]$ | $\frac{1}{2} [ \begin{matrix}0 \\ 1 \\ 0 \\ - 1\end{matrix} ]$ | $\frac{1}{2} [ \begin{matrix}0 \\ 1 \\ 0 \\ j\end{matrix} ]$ | $\frac{1}{2} [ \begin{matrix}0 \\ 1 \\ 0 \\ - j\end{matrix} ]$ | $\frac{1}{2} [ \begin{matrix}1 \\ 1 \\ 1 \\ - 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ 1\end{matrix} ]$ | $\frac{1}{2} [ \begin{matrix}1 \\ 1 \\ - j \\ - j\end{matrix} ]$ |
| 16-23 | $\frac{1}{2} [ \begin{matrix}1 \\ j \\ 1 \\ j\end{matrix} ]$ | $\frac{1}{2} [ \begin{matrix}1 \\ j \\ j \\ 1\end{matrix} ]$ | $\frac{1}{2} [ \begin{matrix}1 \\ j \\ - 1 \\ - j\end{matrix} ]$ | $\frac{1}{2} [ \begin{matrix}1 \\ j \\ - j \\ - 1\end{matrix} ]$ | $\frac{1}{2} [ \begin{matrix}1 \\ - 1 \\ 1 \\ 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ - 1\end{matrix} ]$ | $\frac{1}{2} [ \begin{matrix}1 \\ - 1 \\ - j \\ j\end{matrix} ]$ |
| 24-27 | $\frac{1}{2} [ \begin{matrix}1 \\ - j \\ 1 \\ - j\end{matrix} ]$ | $\frac{1}{2} [ \begin{matrix}1 \\ - j \\ j \\ - 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ 1\end{matrix} ]$ | — | — | — | — |

TABLE 3
Precoding Matrix W For Single-Layer Transmission Using Four
Antenna Ports With Transform Precoding Disabled

| TPMI | W | | | | | | | |
|---|---|---|---|---|---|---|---|---|
| index | (ordered from left to right in increasing order of TPMI index) | | | | | | | |
| 0-7 | $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ | $\frac{1}{2} [ \begin{matrix}1 \\ 0 \\ 1 \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |

| | | | | | | | | |
|---|---|---|---|---|---|---|---|---|
| 8-15 | $\frac{1}{2} [ \begin{matrix}0 \\ 1 \\ 0 \\ 1\end{matrix} ]$ | $\frac{1}{2} [ \begin{matrix}0 \\ 1 \\ 0 \\ - 1\end{matrix} ]$ | $\frac{1}{2} [ \begin{matrix}0 \\ 1 \\ 0 \\ j\end{matrix} ]$ | $\frac{1}{2} [ \begin{matrix}0 \\ 1 \\ 0 \\ - j\end{matrix} ]$ | $\frac{1}{2} [ \begin{matrix}1 \\ 1 \\ 1 \\ 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ - 1\end{matrix} ]$ | $\frac{1}{2} [ \begin{matrix}1 \\ 1 \\ - j \\ - j\end{matrix} ]$ |
| 16-23 | $\frac{1}{2} [ \begin{matrix}1 \\ j \\ 1 \\ j\end{matrix} ]$ | $\frac{1}{2} [ \begin{matrix}1 \\ j \\ j \\ - 1\end{matrix} ]$ | $\frac{1}{2} [ \begin{matrix}1 \\ j \\ - 1 \\ - j\end{matrix} ]$ | $\frac{1}{2} [ \begin{matrix}1 \\ j \\ - j \\ 1\end{matrix} ]$ | $\frac{1}{2} [ \begin{matrix}1 \\ - 1 \\ 1 \\ - 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ 1\end{matrix} ]$ | $\frac{1}{2} [ \begin{matrix}1 \\ - 1 \\ - j \\ j\end{matrix} ]$ |

| | | | | | | | | |
|---|---|---|---|---|---|---|---|---|
| 24-27 | $\frac{1}{2} [ \begin{matrix}1 \\ - j \\ 1 \\ - j\end{matrix} ]$ | $\frac{1}{2} [ \begin{matrix}1 \\ - j \\ j \\ 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ - 1\end{matrix} ]$ | — | — | — | — |

TABLE 4
Precoding Matrix W For Two-Layer Transmission Using
Two Antenna Ports With Transform Precoding Disabled

| TPMI | W | | |
|---|---|---|---|
| index | (ordered from left to right in increasing order of TPMI index) | | |
| 0-2 | $\frac{1}{\sqrt{2}} [ \begin{matrix}1 & 0 \\ 0 & 1\end{matrix} ]$ | $\frac{1}{2} [ \begin{matrix}1 & 1 \\ 1 & - 1\end{matrix} ]$ | $\frac{1}{2} [ \begin{matrix}1 & 1 \\ j & - j\end{matrix} ]$ |

TABLE 5
Precoding Matrix W For Two-Layer Transmission
Using Four Antenna Ports With Transform
Precoding Disabled

| | W | | | |
|---|---|---|---|---|
| TPMI | (ordered from left to right in increasing | | | |
| index | order of TPMI index | | | |
| 0-3 | $\frac{1}{2} [ \begin{matrix}1 & 0 \\ 0 & 1 \\ 0 & 0 \\ 0 & 0\end{matrix} ]$ | $\frac{1}{2} [ \begin{matrix}1 & 0 \\ 0 & 0 \\ 0 & 1 \\ 0 & 0\end{matrix} ]$ | $\frac{1}{2} [ \begin{matrix}1 & 0 \\ 0 & 0 \\ 0 & 0 \\ 0 & 1\end{matrix} ]$ | $\frac{1}{2} [ \begin{matrix}0 & 0 \\ 1 & 0 \\ 0 & 1 \\ 0 & 0\end{matrix} ]$ |
| 4-7 | $\frac{1}{2} [ \begin{matrix}0 & 0 \\ 1 & 0 \\ 0 & 0 \\ 0 & 1\end{matrix} ]$ | $\frac{1}{2} [ \begin{matrix}0 & 0 \\ 0 & 0 \\ 1 & 0 \\ 0 & 1\end{matrix} ]$ | $\frac{1}{2} [ \begin{matrix}1 & 0 \\ 0 & 1 \\ 1 & 0 \\ 0 & - j\end{matrix} ]$ | $\frac{1}{2} [ \begin{matrix}1 & 0 \\ 0 & 1 \\ 1 & 0 \\ 0 & j\end{matrix} ]$ |
| 8-11 | $\frac{1}{2} [ \begin{matrix}1 & 0 \\ 0 & 1 \\ - j & 0 \\ 0 & 1\end{matrix} ]$ | $\frac{1}{2} [ \begin{matrix}1 & 0 \\ 0 & 1 \\ - j & 0 \\ 0 & - 1\end{matrix} ]$ | $\frac{1}{2} [ \begin{matrix}1 & 0 \\ 0 & 1 \\ - 1 & 0 \\ 0 & - j\end{matrix} ]$ | $\frac{1}{2} [ \begin{matrix}1 & 0 \\ 0 & 1 \\ - 1 & 0 \\ 0 & j\end{matrix} ]$ |
| 12-15 | $\frac{1}{2} [ \begin{matrix}1 & 0 \\ 0 & 1 \\ j & 0 \\ 0 & 1\end{matrix} ]$ | $\frac{1}{2} [ \begin{matrix}1 & 0 \\ 0 & 1 \\ j & 0 \\ 0 & - 1\end{matrix} ]$ | $\frac{1}{2 \sqrt{2}} [ \begin{matrix}1 & 1 \\ 1 & 1 \\ 1 & - 1 \\ 1 & - 1\end{matrix} ]$ | $\frac{1}{2 \sqrt{2}} [ \begin{matrix}1 & 1 \\ 1 & 1 \\ j & - j \\ j & - j\end{matrix} ]$ |
| 16-19 | $\frac{1}{2 \sqrt{2}} [ \begin{matrix}1 & 1 \\ j & j \\ 1 & - 1 \\ j & - j\end{matrix} ]$ | $\frac{1}{2 \sqrt{2}} [ \begin{matrix}1 & 1 \\ j & j \\ j & - j \\ - 1 & 1\end{matrix} ]$ | $\frac{1}{2 \sqrt{2}} [ \begin{matrix}1 & 1 \\ - 1 & - 1 \\ 1 & - 1 \\ - 1 & 1\end{matrix} ]$ | $\frac{1}{2 \sqrt{2}} [ \begin{matrix}1 & 1 \\ - 1 & - 1 \\ j & - j \\ - j & j\end{matrix} ]$ |
| 20-21 | $\frac{1}{2 \sqrt{2}} [ \begin{matrix}1 & 1 \\ - j & - j \\ 1 & - 1 \\ - j & j\end{matrix} ]$ | $\frac{1}{2 \sqrt{2}} [ \begin{matrix}1 & 1 \\ - j & - j \\ j & - j \\ 1 & - 1\end{matrix} ]$ | — | — |

TABLE 6
Precoding Matrix W For Three-Layer Transmission Using
Four Antenna Ports With Transform Precoding Disabled

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 \\ 0 & 1 & 0 \\ 0 & 0 & 1 \\ 0 & 0 & 0\end{matrix} ]$ | $\frac{1}{2} [ \begin{matrix}1 & 0 & 0 \\ 0 & 1 & 0 \\ 1 & 0 & 0 \\ 0 & 0 & 1\end{matrix} ]$ | $\frac{1}{2} [ \begin{matrix}1 & 0 & 0 \\ 0 & 1 & 0 \\ - 1 & 0 & 0 \\ 0 & 0 & 1\end{matrix} ]$ | $\frac{1}{2 \sqrt{3}} [ \begin{matrix}1 & 1 & 1 \\ 1 & - 1 & 1 \\ 1 & 1 & - 1 \\ 1 & - 1 & - 1\end{matrix} ]$ |
| 4-6 | $\frac{1}{2 \sqrt{3}} [ \begin{matrix}1 & 1 & 1 \\ 1 & - 1 & 1 \\ j & j & - j \\ j & - j & - j\end{matrix} ]$ | $\frac{1}{2 \sqrt{3}} [ \begin{matrix}1 & 1 & 1 \\ - 1 & 1 & - 1 \\ 1 & 1 & - 1 \\ - 1 & 1 & 1\end{matrix} ]$ | $\frac{1}{2 \sqrt{3}} [ \begin{matrix}1 & 1 & 1 \\ - 1 & 1 & - 1 \\ j & j & - j \\ - j & j & j\end{matrix} ]$ | — |

TABLE 7
Precoding Matrix W For Four-Layer Transmission Using
Four Antenna Ports With Transform Precoding Disabled

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 & 0 \\ 0 & 1 & 0 & 0 \\ 0 & 0 & 1 & 0 \\ 0 & 0 & 0 & 1\end{matrix} ]$ | $\frac{1}{2 \sqrt{2}} [ \begin{matrix}1 & 1 & 0 & 0 \\ 0 & 0 & 1 & 1 \\ 1 & - 1 & 0 & 0 \\ 0 & 0 & 1 & - 1\end{matrix} ]$ | $\frac{1}{2 \sqrt{2}} [ \begin{matrix}1 & 1 & 0 & 0 \\ 0 & 0 & 1 & 1 \\ j & - j & 0 & 0 \\ 0 & 0 & j & - j\end{matrix} ]$ | $\frac{1}{4} [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ]$ |
| 4 | $\frac{1}{4} [ \begin{matrix}1 & 1 & 1 & 1 \\ 1 & - 1 & 1 & - 1 \\ j & j & - j & - j \\ j & - j & - j & j\end{matrix} ]$ | — | — | — |

UE 215 may use a received TPMI to control power for PUSCH transmissions. UE 215 may first calculate a transmission power based on an open-loop or closed-loop power control system. UE 215 may scale the calculated power by a factor (e.g., a factor s), where s may be defined in the following equation (Equation 6):

$$s = \frac{\# nonzero antenna ports}{\# SRS ports per resource} \qquad ( 6 )$$

For example, if a determined W based on a received TPMI is as shown in Equation 7:

$$\frac{1}{2} [ \begin{matrix}1 \\ 0 \\ 0 \\ 0\end{matrix} ] \qquad ( 7 )$$

as shown in Table 2, the value of s would be ¼ since there is one nonzero antenna port (e.g., 1), and four SRS ports per resource (e.g., 1, 0, 0, 0). In another aspect, if a TPMI indicates [1 0] for a calculated transmission power of 26 dBm, then s would be ½, and thus UE 215 may scale the calculated power by ½. That is, UE 215 may scale 26 dBm down by 3 dB to result in 23 dBm (e.g., the power corresponding to 23 dBm may be half that of 26 dBm).

The equation for s may be to scale the calculated power down in a conservative way. For example, UE 215 may report a supported power class (e.g., total 23 dBm or 26 dBm), but may not report an actual capability of one or more PAs (e.g., 26 dBm may be achieved by two 23 dBm collectively). In this way, network node 205 (e.g., the network) may not be able to determine if the UE 215 can transmit full power using a single PA. Additionally, if UE 215 is a non-coherent UE (e.g., may only use a single transmitter or transmission (Tx) at a time) may not transmit at full power (e.g., full power with respect to a supported power class of UE 215).

In some aspects, full power transmissions may be introduced with three modes, and UE 215 may be able to report capability information to network node 205 indicating which of the modes to support. For example, if a parameter ul-FullPowerTransmission in PUSCH-Config is set to fullpower, UE 215 or network node 205 may set s=1. This may indicate that each PA of UE 215 may be able to perform a full power transmission, so UE 215 may not scale the power. In some other aspects, if the parameter ul-FullPowerTransmission in PUSCH-Config is set to fullpowerMode1, UE 215 or network node 205 may set

$$s = \frac{ nonzero antenna ports}{ SRS ports per resource} ,$$

as per Equation 6. Non-coherent UEs, partially coherent UEs, or both, may be able to use fully coherent precoders via transparent small cyclic delay diversity (S-CDD) implementation (e.g., use a TPMI indicating [1 1] to use full power, while an actual precoder might correspond to e(1^{(j*θ(k))}) on a subcarrier k). In some other aspects, if the parameter ul-FullPowerTransmission in PUSCH-Config is set to fullpowerMode2, UE 215 or network node 205 may set s=1 for some TPMIs (e.g., which may depend on UE capability), and

$$s = \frac{\# nonzero antenna ports}{\# SRS ports per resource}$$

for remaining TPMIs, as per Equation 6. Additionally, UE 215 may equally split transmitted power (e.g., after the transmitted power is scaled by s) across the antenna ports transmitted with nonzero power.

However, UE 215 may receive a TPMI (e.g., via control signal 220) that may be a high resolution TPMI. A TPMI may be a precoder that comprises one or more amplitudes, one or more phases, or both. In such cases, the high resolution TPMI may include coefficients that may result in arbitrary amplitude or power applied to antenna ports. For example, UE 215 may receive a TPMI the coefficient amplitude of which is [1, 0.5, 0.5, 0.25], which may include fractional values (e.g., 0.5). Thus, UE 215 may determine a power scaling factor and power splitting for high resolution TPMIs while accounting for PA capabilities for antenna ports of UE 215.

For example, UE 215 may correspond to a power class of 26 dBm, and may include 4 Tx, each with full-rated PA (e.g., full rated with respect to the power class of 26 dBm). UE 215 may thus be able to support any power splitting configuration across the 4 Tx, and may be able to support some or all high resolution TPMIs (e.g., TPMI codewords).

In some other aspects, UE 215 may correspond to a power class of 26 dBm, may include 4Tx, and 4 PAs corresponding to 23 dBm each. If an actual transmission power (e.g., as calculated by closed loop or open loop power control, or by any other method) is 26 dBm each PA may be able to work at most at 50% of the total power (e.g., actual transmission power) (e.g., since 23 dBm may correspond to a power that is half that of 26 dBm). This may mean that the energy of the coefficients (e.g., 1, 0.5, 0.25, or any other values) applied to each antenna port may not exceed 0.5 (e.g., corresponding to 50%) of the total energy of the coefficients applied to the antenna ports collectively (e.g., all antenna ports collectively). For example, a TPMI corresponding to coefficient amplitudes of [1, 0.5, 0.5, 0.25] may be valid, as any individual coefficient (e.g., 1, 0.5, or 0.25) does not exceed 0.5 (e.g., 50%) of the total sum of the coefficients. However, [1, 0.25, 0.25, 0.25] may be invalid, as

$$\frac{1}{( 1 + 0.25 + 0.25 + 0.25 )} > 0.5 .$$

That is, the coefficient 1 makes up approximately 57% of the total sum of the coefficients.

In some other aspects, if an actual transmission power for UE 215 is 23 dBm instead of 26 dBm, and each PA may correspond to 23 dBm each, then UE 215 may be able to support any power splitting configuration across the 4 Tx, and may be able to support some or all high resolution TPMIs (e.g., TPMI codewords).

In some other aspects, UE may consider the actual transmission power, for instance, if UE power class is 26 dBm and each PA can handle 23 dBm, but an actual transmission power for UE 215 is 24.5 dBm then each PA may be able to work at most at approximately 70% of the total power (e.g., 23 dBm may correspond to a power value that is approximately 70% of that of 24.5 dBm). This may mean that energy corresponding to the coefficients applied to each antenna port may not exceed approximately 0.7 of the total energy of the coefficients applied to the antenna ports collectively (e.g., all antenna ports collectively). For example, a TPMI corresponding to coefficient amplitudes of [1, 0.5, 0.5, 0.25] may be valid, and [1, 0.25, 0.25, 0.25] may also be valid as no individual coefficient exceeds approximately 70% or 0.7 of the total sum of the coefficients. Thus, power scaling and splitting techniques for high resolution TPMIs may be considered to scale down PUSCH power or adapt a power splitting ratio to fulfill PUSCH power (e.g., so no PA is allocated too much power).

UE 215 may scale and split power 225 for uplink transmission 230. To scale transmit power for uplink transmission 230 (e.g., PUSCH), UE 215 may scale the uplink transmission 230 transmit power based on the received high-resolution TPMI (e.g., received via control signal 220). For example, UE 215 may calculate a ratio for each antenna port based on coefficient amplitudes from the TPMI, and may determine a scaling factor based on a comparison between the ratio and a threshold. To properly split power for each antenna port, UE 215 may split power for each antenna port based on the received high-resolution TPMI. For example, UE 215 may calculate a ratio for each antenna port based on coefficient amplitudes from the TPMI, and may determine how power is to be split across antenna ports based on a comparison between the ratio and a threshold. By scaling and splitting power 225 for uplink transmission 230 in either of these ways, UE 215 may be able to correctly allocate power to antenna ports for transmission when receiving high-resolution TPMIs.

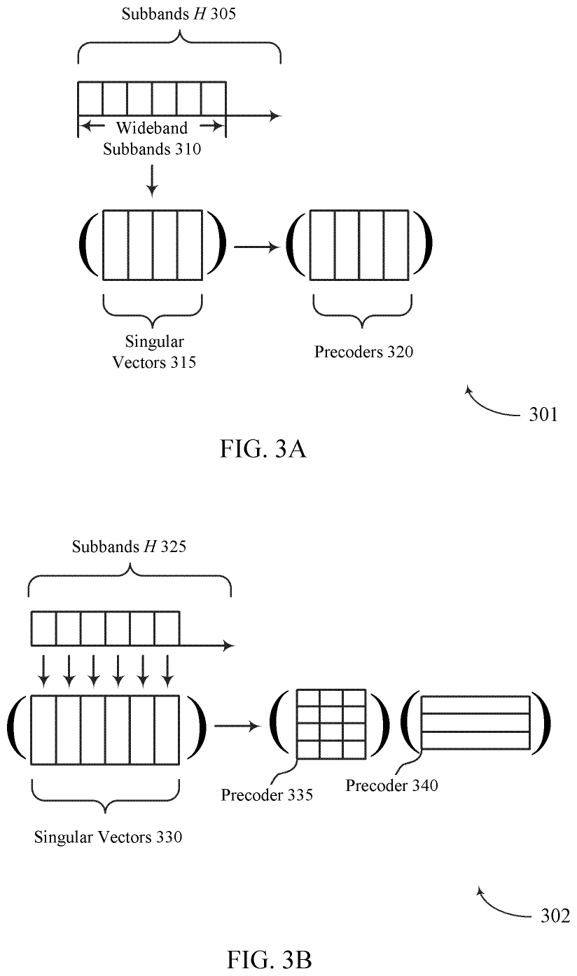

FIG. 3A illustrates an example of a first codebook scheme 301 that supports power scaling and splitting for uplink high resolution TPMI in accordance with one or more aspects of the present disclosure. The first codebook scheme 301 may implement or be implemented by aspects of the wireless communications system 100, wireless communications system 200, or both, as described with reference to FIG. 1 and FIG. 2.

In some wireless communications systems, a UE or a network node may use codebook based (CB) or non codebook based (NCB) schemes for uplink transmissions. Some NCB schemes for uplink transmissions may use singular value decomposition (SVD) of a channel, and may use full channel reciprocity. Some CB schemes for uplink transmissions may perform less desirably than NCB due to low-resolution quantization of an SVD precoder.

A first candidate codebook scheme may be illustrated by the first codebook scheme 301. A wideband precoder with a high resolution TPMI may be represented in the following equation (Equation 8):

$$W = [ {\underbrace{{W}_{0} , ⋯ {W}_{v - 1}}}_{layer 0 to v - 1} ] = [ \begin{matrix}{c}_{0 , 0} & ⋯ & {c}_{0 , v - 1} \\ ⋮ & ⋱ & ⋮ \\ {c}_{{N}_{tx} - 1 , 0} & ⋯ & {c}_{{N}_{tx} - 1 , v - 1}\end{matrix} ] \qquad ( 8 )$$

In such cases, c_{i,l} may be indicated via quantization (e.g., amplitude/phase quantization). A network node may calculate an SVD of the channel estimation (e.g., rather than selecting a precoder from a table). The network node may calculate a wideband SVD using wideband subbands 310 of subbands H 305 (e.g., wideband subbands 310 may correspond to six subbands for H, that is, H_{WB}=[H₀, H₁, H₂, H₃, H₄, H₅]) using SVD(H_{WB} [symbol] ^{H}) to obtain singular vectors 315 of the wideband matrix (e.g., singular vectors 315 may correspond to V₀, V₁, V₂, V₃, or more. Each column of the singular vectors 315 may correspond to layer indices (e.g., 0, 1, 2, 3), and each row of the singular vectors 315 may correspond to SRS port indices (e.g., 0, 1, 2, 3). The network node may quantize each element (e.g., corresponding to each layer) of singular vectors 315 (e.g., V₀, V₁, V₂, V₃) into precoders 320 (e.g., corresponding to W₀, W₁, W₂, W₃. Each column of the precoders 320 may correspond to layer indices (e.g., 0, 1, 2, 3), and each row of the precoders 320 may correspond to SRS port indices (e.g., 0, 1, 2, 3).

FIG. 3B illustrates an example of a second codebook scheme 302 that supports power scaling and splitting for an uplink high resolution TPMIs in accordance with aspects of the present disclosure. The second codebook scheme 302 may implement or be implemented by aspects of the wireless communications system 100, wireless communications system 200, or both, as described with reference to FIG. 1 and FIG. 2.

A second candidate codebook scheme may be illustrated by the second codebook scheme 302. A precoder for high resolution TPMI with frequency selective precoding may be represented by the following equation (Equation 9):

$${W}_{l} = {W}_{2 , l} \times {W}_{f , l} \qquad ( 9 )$$

Equation 9 may be of size Nₜₓ×N_{SB} and Wₗ may be a precoder for layer l across N_{SB} uplink subbands. W_{2,l} may be the Nₜₓ×M sparse coefficients matrix, and each coefficient may be indicated via quantization (e.g., amplitude/phase quantization). W_{f,l} may be of size M×N_{SB} and may include M FD bases. For frequency selective precoding, a network node may calculate SVD for one or more subbands of subbands H 325. The network node may calculate SVDs for one or more subbands H 325 (e.g., may correspond to six subbands for H, that is, H₀, H₁, H₂, H₃, H₄, and H₅) using SVD(Hₙ [symbol] ) to obtain singular vectors 330 (e.g., singular vectors 330 may correspond to V_{0,l}, V_{1,l}, V_{2,l}, V_{3,l}, V_{4,l}, V_{5,l}, for a given layer denoted by l). Each row of the singular vectors 315 may correspond to SRS port indices (e.g., 0, 1, 2, 3). The network node may compress and quantize a precoder based on each element of singular vectors 330 (e.g., V_{0,l}, V_{1,l}, V_{2,l}, V_{3,l}, V_{4,l}, V_{5,l}). After compression and quantization, the network node may calculate precoder 335 (e.g., W_{2,l}) and precoder 340 (e.g., W_{f,l}) (e.g., precoder 340 may include, factor in, or correspond to frequency domain compression). Each column of precoder 335 may correspond to FD basis indices (e.g., 0, 1, 2). Each column of precoder 340 may correspond to subband indices (e.g., 0, 1, 2, 3, 4, 5), and each row of precoder 340 may correspond to a vector (e.g., any of f₀, f₁, f₂, f₃). Multiplied together, precoder 335 and precoder 340 may result in a precoder Wₗ for layer l as shown in Equation 9.

For frequency selective precoding, uplink subband precoding as a linear combination of FD basis may be considered. An uplink precoder of a layer l∈{0, . . . , v−1} across N₃ FD units may be represented in the following equation (Equation 10):

$$\frac{1}{\sqrt{v}} \times [ \begin{matrix}{\sum }_{m = 0}^{{M}_{0 , l} - 1} {c}_{0 , m , l} \cdot {f}_{{k}_{0 , m , l}}^{\\ H} \\ {\sum }_{m = 0}^{{M}_{1 , l} - 1} {c}_{1 , m , l} \cdot {f}_{{k}_{1 , m , l}}^{\\ H} \\ ⋮ \\ {\sum }_{m = 0}^{{M}_{p - 1 , l} - 1} {c}_{p - 1 , m , l} \cdot {f}_{{k}_{p - 1 , m , l}}^{\\ H}\end{matrix} ] \qquad ( 10 )$$

where fₖ_{_{i,m,l}}^{H} of size 1×N₃ may be the m-th FD basis applied to SRS port i of layer l, and c_{0,m,l} may be the linear combination coefficient associated with basis fₖ_{_{i,m,l}}^{H}. Each port may correspond to an FD unit, as shown in the following table, where each row may correspond to port 0, port 1, port 2, and port 3, and each column may correspond to FD unit 0, FD unit 1, . . . , FD unit N₃−1:

TABLE 8
Frequency Selective Precoding, FD Units and Ports

| | |
|---|---|
| Σₘ₌₀^{M}_{^{0, l}}⁻¹c_{0, m, l} · fₖ_{_{0, m, l}}^{H}[0] | Σₘ₌₀^{M}_{^{0, l}}⁻¹c_{0, m, l} · fₖ_{_{0, m, l}}^{H}[1] |
| Σₘ₌₀^{M}_{^{1, l}}⁻¹c_{1, m, l} · fₖ_{_{1, m, l}}^{H}[0] | Σₘ₌₀^{M}_{^{1, l}}⁻¹c_{1, m, l} · fₖ_{_{1, m, l}}^{H}[1] |
| Σₘ₌₀^{M}_{^{2, l}}⁻¹c_{2, m, l} · fₖ_{_{2, m, l}}^{H}[0] | Σₘ₌₀^{M}_{^{2, l}}⁻¹c_{2, m, l} · fₖ_{_{2, m, l}}^{H}[1] |
| Σₘ₌₀^{M}_{^{3, l}}⁻¹c_{3, m, l} · fₖ_{_{3, m, l}}^{H}[0] | Σₘ₌₀^{M}_{^{3, l}}⁻¹c_{3, m, l} · fₖ_{_{3, m, l}}^{H}[1] |
| . . . | Σₘ₌₀^{M}_{^{0, l}}⁻¹c_{0, m, l} · fₖ_{_{0, m, l}}^{H}[N₃ − 1] |
| . . . | Σₘ₌₀^{M}_{^{1, l}}⁻¹c_{1, m, l} · fₖ_{_{1, m, l}}^{H}[N₃ − 1] |
| . . . | Σₘ₌₀^{M}_{^{2, l}}⁻¹c_{2, m, l} · fₖ_{_{2, m, l}}^{H}[N₃ − 1] |
| . . . | Σₘ₌₀^{M}_{^{3, l}}⁻¹c_{3, m, l} · fₖ_{_{3, m, l}}^{H}[N₃ − 1] |

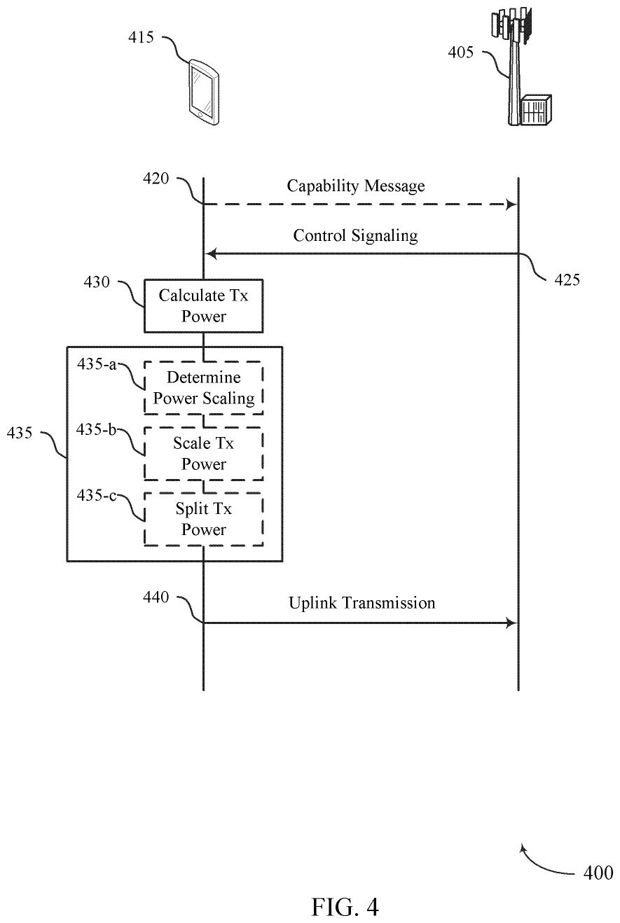

FIG. 4 illustrates an example of a process flow 400 that supports power scaling and splitting for uplink high resolution TPMI in accordance with one or more aspects of the present disclosure. The process flow 400 may implement or be implemented by aspects of the wireless communications system 100, wireless communications system 200, or a combination of these, as described with reference to FIG. 1 and FIG. 2. In some aspects, the process flow 400 may include example operations associated with network node 405 and UE 415, which may be examples of corresponding devices described with reference to FIGS. 1 and 2. In the following description of the process flow 400, the operations between network node 405 and UE 415 may be performed in a different order than the example order shown, or the operations performed by network node 405 and UE 415 may be performed in different orders or at different times. Some operations may also be omitted from the process flow 400, and other operations may be added to the process flow 400.

At 420, UE 415 may transmit, to network node 405, a capability message indicating a threshold (e.g., γ_{i,thr}, or any other threshold) for a comparison. In some aspects, UE 415 may transmit the capability message for each port of one or more antenna ports of UE 415. That is, the capability message indicating the threshold (e.g., an amplitude or a power threshold) may be a per port reporting per total number of ports (e.g., γ_{i,N,thr}). For a 4-port case, UE 415 may transmit using each port from one Tx. For a 2-port case, UE 415 may formulate a port using >1 Tx, resulting in different thresholds (e.g., amplitude/power thresholds) for 2-port compared to 4-port cases. For example, for a 4-port case, UE 415 may report the threshold of each port being equal to 0.5. For a 2-port case, UE 415 may report the threshold for a first port (e.g., port0) as 1, while UE 415 may report a threshold for a second port (e.g., port1) as 0.5. In some cases, the threshold (e.g., amplitude/power threshold) may be updated dynamically by an uplink MAC control element (MAC-CE). In some cases, the threshold may be port-common, or port-specific.

At 425, UE 415 may receive, from network node 405, control signaling that includes a TPMI (e.g., a high resolution TPMI) which may indicate a precoder to be applied by UE 415 in transmitting an uplink shared channel. The TPMI may include or indicate one or more coefficients corresponding to one or more amplitudes (e.g., [1, 0.5, 0.5, 0.25] may be examples of coefficients for a TPMI).

At 430, UE 415 may calculate an initial Tx power (e.g., PUSCH transmission power) for transmitting the uplink shared channel. For example, UE 415 may calculate the power according to open loop or closed loop power control systems or processes.

At 435, UE 415 may modify the initial transmission power to determine a modified transmission power, where modification of the initial transmission power may be based on one or more amplitudes of one or more coefficients associated with the TPMI. Such modification may include one or more steps, processes, features, or the like as described with reference to 435-a through 435-c.

At 435-a, UE 415 may determine a power scaling factor (e.g., a power scaling factor s) based on a ratio of at least one of the one or more amplitudes (e.g., of the coefficients included in or indicated by the received high resolution TPMI) divided by an aggregate of the one or more amplitudes, and based on a comparison of the ratio with the threshold. That is, s may depend on a ratio of amplitudes of the coefficients (e.g., aggregating all layers and all precoders across a frequency if frequency selective precoding) on each antenna port over the total (e.g., sum) coefficient amplitude (e.g., aggregating all layers) on the antenna ports (e.g., all the antenna ports). In some aspects, UE 415 may assign a first value to the power scaling factor if the ratio is less than or equal to the threshold, or a second value to the power scaling factor if the ratio is greater than or equal to the threshold. For example, if the ratio is less than or equal to the threshold, UE 415 may set s equal to a first value (e.g., 1), otherwise (e.g., if the ratio of at least one port is greater than its corresponding ratio), UE 415 may set s equal to a second value. That is, UE 415 may determine respective ratios for antenna ports i as γᵢ=Σᵥ₌₀^{rank-1}c_{i,v}/Σᵢ₌₀^{N}^{ₜ}⁻¹Σᵥ₌₀^{rank-1}c_{i,v}. If all γᵢ≤γ_{i,thr}, ∀i=0, . . . , Nₜ−1, then s=1; otherwise, s may be determined based on the smallest threshold where the ratio is greater than the threshold. That is, s=γ_{i*,thr}/γ_{i*}, where i*=argmin_{γ}_{ᵢ}_{>γi,thr}γ_{i,thr}. In some aspects, γ_{i,thr} may be interpreted as a highest power ratio for antenna port i if UE 415 transmits the uplink shared channel (e.g., PUSCH) under max power.

In some aspects, if there are greater than 1 ports exceeding a respective threshold, the second value may be based on a smallest ratio of the determined the ratio over the respective threshold, among all the ports exceeding the respective threshold. In this case,

$$s = \frac{{γ}_{{i}^{*} , thr}}{{γ}_{{i}^{*}}} ,$$

where i*=argmin_{γ}_{ᵢ}_{>γi,thr}γ_{i,thr}/γᵢ. The determined ratio may be γᵢ, and the ratio of the determined ratio over the respective threshold is

$$\frac{{γ}_{i , thr}}{{γ}_{i}} ,$$

and the smallest

$$\frac{{γ}_{{i}^{*} , thr}}{{γ}_{{i}^{*}}} ,$$

may be used as the scaled power.

At 435-b, UE 415 may scale the initial transmission power by the power scaling factor to determine a scaled transmission power, the power scaling factor based on one or more amplitudes of one or more coefficients associated with the TPMI.

For example, UE 415 with a power class of 26 dBm may include 4 Tx with four PAs corresponding to 23 dBm each. UE 415 may report {0.5, 0.5, 0.5, 0.5} as the threshold for each antenna port of the 4 Tx (e.g., 23 dBm may correspond to a power value that is half that of 26 dBm). If network node 405 transmits control signaling at 425 indicating a TPMI of, as shown in Equation 11:

$$[ \begin{matrix}{c}_{0 , 0} \cdot {e}^{j {θ}_{0 , 0}} & {c}_{0 , 1} \cdot {e}^{j {θ}_{0 , 1}} \\ {c}_{1 , 0} \cdot {e}^{j {θ}_{1 , 0}} & {c}_{1 , 1} \cdot {e}^{j {θ}_{1 , 1}} \\ {c}_{2 , 0} \cdot {e}^{j {θ}_{2 , 0}} & {c}_{2 , 1} \cdot {e}^{j {θ}_{2 , 1}} \\ {c}_{3 , 0} \cdot {e}^{j {θ}_{3 , 0}} & {c}_{3 , 1} \cdot {e}^{j {θ}_{3 , 1}}\end{matrix} ] \qquad ( 11 )$$

where, as shown in Equation 12:

$$[ \begin{matrix}{\vert {c}_{0 , 0} \vert}^{2} + {\vert {c}_{0 , 1} \vert}^{2} \\ {\vert {c}_{1 , 0} \vert}^{2} + {\vert {c}_{2 , 1} \vert}^{2} \\ {\vert {c}_{2 , 0} \vert}^{2} + {\vert {c}_{2 , 1} \vert}^{2} \\ {\vert {c}_{3 , 0} \vert}^{2} + {\vert {c}_{3 , 1} \vert}^{2}\end{matrix} ] = [ \begin{matrix}1 \\ 0.5 \\ 0.5 \\ 0.5\end{matrix} ] \qquad ( 12 )$$

UE 415 may calculate, as shown in Equation 13:

$$[ \begin{matrix}{γ}_{0} \\ {γ}_{1} \\ {γ}_{2} \\ {γ}_{3}\end{matrix} ] = [ \begin{matrix}0.4 \\ 0.2 \\ 0.2 \\ 0.2\end{matrix} ] \qquad ( 13 )$$

as each ratio corresponding to each antenna port. UE 415 may compare a given ratio (e.g., γᵢ) with the threshold 0.5, and may determine that the scaling factor s equals 1 since γᵢ<0.5 for any i. UE 415 may scale the transmission power by 1 (e.g., the value of s).

In some other aspects, if network node 405 transmits control signaling at 425 indicating a TPMI of, as shown in Equation 14:

$$[ \begin{matrix}{c}_{0 , 0} \cdot {e}^{j {θ}_{0 , 0}} & {c}_{0 , 1} \cdot {e}^{j {θ}_{0 , 1}} \\ {c}_{1 , 0} \cdot {e}^{j {θ}_{1 , 0}} & {c}_{1 , 1} \cdot {e}^{j {θ}_{1 , 1}} \\ {c}_{2 , 0} \cdot {e}^{j {θ}_{2 , 0}} & {c}_{2 , 1} \cdot {e}^{j {θ}_{2 , 1}} \\ {c}_{3 , 0} \cdot {e}^{j {θ}_{3 , 0}} & {c}_{3 , 1} \cdot {e}^{j {θ}_{3 , 1}}\end{matrix} ] \qquad ( 14 )$$

where, as shown in Equation 15:

$$[ \begin{matrix}{\vert {c}_{0 , 0} \vert}^{2} + {\vert {c}_{0 , 1} \vert}^{2} \\ {\vert {c}_{1 , 0} \vert}^{2} + {\vert {c}_{2 , 1} \vert}^{2} \\ {\vert {c}_{2 , 0} \vert}^{2} + {\vert {c}_{2 , 1} \vert}^{2} \\ {\vert {c}_{3 , 0} \vert}^{2} + {\vert {c}_{3 , 1} \vert}^{2}\end{matrix} ] = [ \begin{matrix}1 \\ 0.25 \\ 0.25 \\ 0.25\end{matrix} ] \qquad ( 15 )$$

UE 415 may calculate, as shown in Equation 16:

$$[ \begin{matrix}{γ}_{0} \\ {γ}_{1} \\ {γ}_{2} \\ {γ}_{3}\end{matrix} ] = [ \begin{matrix}4 / 7 \\ 1 / 7 \\ 1 / 7 \\ 1 / 7\end{matrix} ] \qquad ( 16 )$$

as each ratio corresponding to each antenna port. UE 415 may compare a given ratio (e.g., γᵢ) with the threshold 0.5, and may determine that the scaling factor

$$s = \frac{0.5}{\frac{4}{7}} = 7 / 8$$

since

$${γ}_{0} = \frac{4}{7} > 0.5 .$$

UE 415 may scale the transmission power by ⅞ (e.g., the value of s).

In some aspects, UE 415 may determine the power scaling factor based additionally on the initial transmission power (e.g., PUSCH transmission power) and one or more parameters included in a power headroom report (e.g., the PUSCH transmission power may be calculated from a parameter P_{C,max} and a power headroom parameter in a power headroom report). In some aspects, the power headroom report that includes at least one of the one or more parameters is a per antenna port power headroom report for the one or more antenna ports. In some aspects, the threshold may be a scaled threshold.

The power scaling factor s may depend on a ratio of amplitudes of the coefficients (e.g., aggregating all layers and all precoders across a frequency if frequency selective precoding) on each antenna port over the total (e.g., sum) coefficient amplitude (e.g., aggregating all layers) on the antenna ports (e.g., all the antenna ports), the ratio compared to the scaled threshold. If the ratio is less than or equal to the scaled threshold, UE 415 may set s equal to a first value (e.g., 1), otherwise (e.g., if the ratio of at least one port is greater than its corresponding ratio), UE 415 may set s equal to a second value. That is, UE 415 may determine respective ratios for antenna ports i as γᵢ=Σᵥ₌₀^{rank-1}c_{i,v}/Σᵢ₌₀^{N}^{ₜ}⁻¹Σᵥ₌₀^{rank-1}c_{i,v}. If all γᵢ≤γ_{i,thr}, ∀i=0, . . . , Nₜ−1, then s=1; otherwise, s may be determined based on the smallest threshold where the ratio is greater than the threshold. That is, s=\hat{γ}_{i*,thr}/γ_{i*}, where i*=argmin_{γ}_{ᵢ}_{>\hat{γ}i,thr}\hat{γ}_{i,thr}, where

$${\hat{γ}}_{i , thr} = {γ}_{i , thr} / ( \frac{{P}_{PUSCH , b , f , c}}{{P}_{cmax , f , c}} ) ,$$

and P_{cmax,f,c} may be a configured max power (e.g., on a carrier f of a serving cell c), and P_{PUSCH,b,f,c} may be the calculated PUSCH power, and P_{PUSCH,b,f,c}=max(0, P_{cmax,f,c}−PH_{type1,b,f,c}), where PH_{type1,b,f,c} may be the power headroom on bandwidth part b of carrier f of serving cell c.

For example, UE 415 with a power class of 26 dBm may include 4 Tx with four PAs corresponding to 23 dBm each. UE 415 may report {0.5, 0.5, 0.5, 0.5} as the threshold for each antenna port of the 4 Tx (e.g., 23 dBm may correspond to a power value that is half that of 26 dBm). Based on uplink power control (e.g., open loop, closed loop), UE 415 may calculate the actual uplink transmission (e.g., PUSCH) power of 24.5 dBm, while P_{C,max}=26 dBm. If network node 405 transmits control signaling at 425 indicating a TPMI of, as shown in Equation 17:

$$[ \begin{matrix}{c}_{0 , 0} \cdot {e}^{j {θ}_{0 , 0}} & {c}_{0 , 1} \cdot {e}^{j {θ}_{0 , 1}} \\ {c}_{1 , 0} \cdot {e}^{j {θ}_{1 , 0}} & {c}_{1 , 1} \cdot {e}^{j {θ}_{1 , 1}} \\ {c}_{2 , 0} \cdot {e}^{j {θ}_{2 , 0}} & {c}_{2 , 1} \cdot {e}^{j {θ}_{2 , 1}} \\ {c}_{3 , 0} \cdot {e}^{j {θ}_{3 , 0}} & {c}_{3 , 1} \cdot {e}^{j {θ}_{3 , 1}}\end{matrix} ] \qquad ( 17 )$$

where, as shown in Equation 18:

$$[ \begin{matrix}{\vert {c}_{0 , 0} \vert}^{2} + {\vert {c}_{0 , 1} \vert}^{2} \\ {\vert {c}_{1 , 0} \vert}^{2} + {\vert {c}_{1 , 1} \vert}^{2} \\ {\vert {c}_{2 , 0} \vert}^{2} + {\vert {c}_{2 , 1} \vert}^{2} \\ {\vert {c}_{3 , 0} \vert}^{2} + {\vert {c}_{3 , 1} \vert}^{2}\end{matrix} ] = [ \begin{matrix}1 \\ 0.25 \\ 0.25 \\ 0.25\end{matrix} ] \qquad ( 18 )$$

UE 415 may calculate, as shown in Equation 19:

$$[ \begin{matrix}{γ}_{0} \\ {γ}_{1} \\ {γ}_{2} \\ {γ}_{3}\end{matrix} ] = [ \begin{matrix}4 / 7 \\ 1 / 7 \\ \begin{matrix}1 / 7 \\ 1 / 7\end{matrix}\end{matrix} ] \qquad ( 19 )$$

as each ratio corresponding to each antenna port. UE 415 may compare γᵢ with the adjusted (e.g., scaled) threshold. That is,

$${\hat{γ}}_{0 , thr} = \frac{0.5}{\frac{{P}_{PUSCH , linear}}{{P}_{C , max , linear}}} \approx 0.7 ,$$

and UE 415 may determine that the scaling factor s=1, since

$${γ}_{0} = \frac{4}{7} > 0.7 .$$

In some aspects, the threshold may be port-specific. In some aspects, the threshold may be common for the one or more antenna ports.

In some cases, the power headroom reporting of P_{C,max} and/or power headroom may be per uplink transmission (e.g., PUSCH) port, or per Tx, instead of per carrier per serving cell for P_{C,max} and per bandwidth part per carrier per serving cell for power headroom. For example, if power headroom is reported per PUSCH port or per Tx, then the threshold may be defined as

$${\hat{γ}}_{i , thr} = {γ}_{i , thr} / ( \frac{{P}_{PUSCH , b , f , c , i}}{{P}_{cmax , f , c}} ) .$$

In some other aspects, if P_{C,max} is per PUSCH port or per Tx, then the threshold may be defined as

$${\hat{γ}}_{i , thr} = {γ}_{i , thr} / ( \frac{{P}_{PUSCH , b , f , c}}{{P}_{cmax , f , c , i}} ) .$$

In some other aspects, if both power headroom and P_{C,max} are per PUSCH port or per Tx, then the threshold may be defined as

$${\hat{γ}}_{i , thr} = {γ}_{i , thr} / ( \frac{{P}_{PUSCH , b , f , c , i}}{{P}_{cmax , f , c , i}} ) .$$

Additionally, or alternatively, UE 415 may scale the initial transmission power by a power scaling factor to determine a scaled transmission power. In some aspects UE 415 may scale the initial transmission power by the power scaling factor that is defined as a quantity of non-zero antenna ports divided by a quantity of SRS antenna ports. For example, UE 415 may scale the initial transmission power by s as mentioned in Equation 6.

At 435-c, UE 415 may split the scaled transmission power across one or more antenna ports. In some aspects, UE 415 may split the scaled transmission power based on the ratio. For example, after scaling, UE 415 may split the power across antenna ports based on the ratio γᵢ. For example, the power allocated to antenna i of layer v may be based on the ratio of the coefficient amplitude c_{i,v} over the total coefficient amplitude collectively (e.g., based on the ratio c_{i,v}/Σᵢ₌₀^{N}^{ₜ}⁻¹Σᵥ₌₀^{rank-1}c_{i,v}).

For example, if UE 415 calculates, as shown in Equation 20:

$$[ \begin{matrix}{γ}_{0} \\ {γ}_{1} \\ {γ}_{2} \\ {γ}_{3}\end{matrix} ] = [ \begin{matrix}0.4 \\ 0.2 \\ 0.2 \\ 0.2\end{matrix} ] \qquad ( 20 )$$

as each ratio corresponding to each antenna port, UE 415 may distribute the uplink shared channel power (e.g., PUSCH power) across antenna ports (e.g., 0, 1, 2, and 3) based on γᵢ as 0.4, 0.2, 0.2, and 0.2, respectively.

In some other aspects, if UE 415 calculates, as shown in Equation 21:

$$[ \begin{matrix}{γ}_{0} \\ {γ}_{1} \\ {γ}_{2} \\ {γ}_{3}\end{matrix} ] = [ \begin{matrix}4 / 7 \\ 1 / 7 \\ \begin{matrix}1 / 7 \\ 1 / 7\end{matrix}\end{matrix} ] \qquad ( 21 )$$

as each ratio corresponding to each antenna port, UE 415 may distribute the uplink shared channel power (e.g., PUSCH power) across antenna ports (e.g., 0, 1, 2, and 3) based on γᵢ as 4/7, 1/7, 1/7, and 1/7, respectively.

Further, UE 415 may distribute the uplink shared channel power (e.g., PUSCH power) allocated to each antenna across one or more layers based on the ratio between |c_{i,0}|² and |c_{i,1}|².

Additionally, or alternatively, UE 415 may split the scaled transmission power across one or more antenna ports based on one or more amplitudes of one or more coefficients associated with the TPMI (e.g., the high resolution TPMI). In some aspects, UE 415 may calculate one or more power ratios corresponding to each of the one or more antenna ports based on the one or more amplitudes of the one or more coefficients associated with the TPMI. That is, UE 415 may determine a ratio for antenna port i as γᵢ=Σᵥ₌₀^{rank-1}c_{i,v}/Σᵢ₌₀^{N}^{ₜ}⁻¹Σᵥ₌₀^{rank-1}c_{i,v} (e.g., UE 415 may also aggregate all precoders across a frequency if configured for frequency selective precoding).

UE 415 may compare each of the one or more power ratios with a threshold, where a first portion of the one or more antenna ports that correspond to power ratios exceeding the threshold include a first set of antenna ports, and a second portion of the one or more antenna ports that correspond to power ratios not exceeding the threshold include a second set of antenna ports. UE 415 may set respective power ratios for the first set of antenna ports equal to the threshold based on the power ratios exceeding the threshold. UE 415 may allocate a remaining power to the second set of antenna ports based on the one or more power ratios. UE 415 may repeat the setting and the allocating until the one or more power ratios corresponding to each of the one or more antenna ports are less than or equal to the threshold.

That is, if a ratio is greater than the threshold, the power ratio may be given by the threshold. For example, for all γᵢ≥γ_{i,thr}, ∀i=0, . . . , Nₜ−1, UE 415 may determine \hat{γ}ᵢ=γ_{i,thr}. The remaining power, that is, P_{PUSCH}×s×(1−Σ_{γ}_{ᵢ}_{>γi,thr}\hat{γ}ᵢ), may be assigned to other ports where γᵢ<γ_{i,thr} may be proportional to the power ratio obtained from the calculated TPMI, and UE 415 may determine that

$${\hat{γ}}_{i} = {γ}_{i} \times \frac{( 1 - {\sum }_{{γ}_{i} > {γ}_{i , thr}} {\hat{γ}}_{i} )}{( 1 - {\sum }_{{γ}_{i} > {γ}_{i , thr}} {γ}_{i} )} .$$

UE 415 may repeat these steps until all \hat{γ}ᵢ≤γ_{i,thr}.

In some cases, the threshold γ_{i,thr} may be port-common, or port-specific, and may be signaled by UE as capability (e.g., at 420). The threshold γ_{i,thr} may be interpreted as a highest power ratio for an antenna port i if the uplink transmission (e.g., PUSCH) is transmitted at (additionally, or alternatively, under) max power. Further, for each of the one or more antenna ports, the one or more power ratios across one or more transmission layers may be based on amplitudes of the one or more transmission layers. That is, for each antenna port of UE 415, the one or more power splitting ratio across layers may be based on the one or more amplitudes of the corresponding layers.

In some aspects, the splitting may include UE 415 splitting the scaled transmission power (e.g., PUSCH power) based additionally on the initial transmission power and one or more parameters included in a power headroom report. (e.g., the PUSCH transmission power may be calculated from a parameter P_{C,max} and a power headroom parameter in a power headroom report). For example, UE 415 may split the scaled transmission power across one or more antenna ports based on one or more amplitudes of one or more coefficients associated with the TPMI (e.g., the high resolution TPMI). In some aspects, UE 415 may calculate one or more power ratios corresponding to each of the one or more antenna ports based on the one or more amplitudes of the one or more coefficients associated with the TPMI. That is, UE 415 may determine a ratio for antenna port i as γᵢ=Σᵥ₌₀^{rank-1}c_{i,v}/Σᵢ₌₀^{N}^{ₜ}⁻¹Σᵥ₌₀^{rank-1}c_{i,v} (e.g., UE 415 may also aggregate all precoders across a frequency if configured for frequency selective precoding.

UE 415 may compare each of the one or more power ratios with a threshold. That is, if a ratio is greater than the threshold, the power ratio may be given by the threshold. For example, for γᵢ≥\hat{γ}_{i,thr}, ∀i=0, . . . , Nₜ−1, UE 415 may determine \hat{γ}ᵢ=\hat{γ}_{i,thr}. In some cases,

$${\hat{γ}}_{i , thr} = \frac{{γ}_{i , thr}}{\frac{{P}_{PUSCH , b , f , c}}{{P}_{cmax , f , c}}} ,$$

where P_{cmax,f,c} may be the configured max power (on the carrier f of serving cell c), P_{PUSCH,b,f,c} may be the calculated uplink transmission (e.g., PUSCH) power, and P_{PUSCH,b,f,c}=max(0, P_{cmax,f,c}−PH_{type1,b,f,c}), where PH_{type1,b,f,c} may be the power headroom on a bandwidth part b of a carrier f of a serving cell c. The remaining power, that is, P_{PUSCH}×s×(1−Σ_{γi>\hat{γ}i,thr}\hat{γ}ᵢ), may be assigned to other ports where γᵢ<\hat{γ}_{i,thr} may be proportional to the power ratio obtained from the calculated TPMI, and UE 415 may determine that

$${\hat{γ}}_{i} = {γ}_{i} \times \frac{( 1 - {\sum }_{{γ}_{i} > {\hat{γ}}_{i , thr}} {\hat{γ}}_{i} )}{( 1 - {\sum }_{{γ}_{i} > {\hat{γ}}_{i , thr}} {γ}_{i} )} .$$

UE 415 may repeat these steps until all \hat{γ}ᵢ≤\hat{γ}_{i,thr}.

For example, UE 415 with a power class of 26 dBm may include 4 Tx with four PAs corresponding to 23 dBm each. UE 415 may report {0.5, 0.5, 0.5, 0.5} as the threshold for each antenna port of the 4 Tx (e.g., 23 dBm may correspond to a power value that is half that of 26 dBm). Based on uplink power control (e.g., open loop, closed loop), UE 415 may calculate the actual uplink transmission (e.g., PUSCH) power of 24.5 dBm, while P_{C,max}=26 dBm. UE 415 may determine a power scaling factor s=1. If network node 405 transmits control signaling at 425 indicating a TPMI of, as shown in Equation 22:

$$[ \begin{matrix}{c}_{0 , 0} \cdot {e}^{j {θ}_{0 , 0}} & {c}_{0 , 1} \cdot {e}^{j {θ}_{0 , 1}} \\ {c}_{1 , 0} \cdot {e}^{j {θ}_{1 , 0}} & {c}_{1 , 1} \cdot {e}^{j {θ}_{1 , 1}} \\ {c}_{2 , 0} \cdot {e}^{j {θ}_{2 , 0}} & {c}_{2 , 1} \cdot {e}^{j {θ}_{2 , 1}} \\ {c}_{3 , 0} \cdot {e}^{j {θ}_{3 , 0}} & {c}_{3 , 1} \cdot {e}^{j {θ}_{3 , 1}}\end{matrix} ] \qquad ( 22 )$$

where, as shown in Equation 23:

$$[ \begin{matrix}{\vert {c}_{0 , 0} \vert}^{2} + {\vert {c}_{0 , 1} \vert}^{2} \\ {\vert {c}_{1 , 0} \vert}^{2} + {\vert {c}_{1 , 1} \vert}^{2} \\ {\vert {c}_{2 , 0} \vert}^{2} + {\vert {c}_{2 , 1} \vert}^{2} \\ {\vert {c}_{3 , 0} \vert}^{2} + {\vert {c}_{3 , 1} \vert}^{2}\end{matrix} ] = [ \begin{matrix}1 \\ 0.25 \\ 0.25 \\ 0.25\end{matrix} ] \qquad ( 23 )$$

UE 415 may calculate, as shown in Equation 24:

$$[ \begin{matrix}{γ}_{0} \\ {γ}_{1} \\ {γ}_{2} \\ {γ}_{3}\end{matrix} ] = [ \begin{matrix}4 / 7 \\ 1 / 7 \\ 1 / 7 \\ 1 / 7\end{matrix} ] \qquad ( 24 )$$

as each ratio corresponding to each antenna port. UE 415 may compare γᵢ with the adjusted (e.g., scaled) threshold. That is,

$${\hat{γ}}_{i , thr} = \frac{0.5}{\frac{{P}_{PUSCH , linear}}{{P}_{C , max , linear}}} \approx 0.7 .$$

UE 415 may determine that the power splitting ratio γ₀=0.5 and remaining power may be P_{PUSCH,linear}=1−0.5 while

$${\hat{γ}}_{1} = {\hat{γ}}_{2} = {\hat{γ}}_{3} = \frac{1}{7} * \frac{( 1 - 0.5 )}{1 - \frac{4}{7}} = 1 / 6 \approx 0.167 .$$

Thus, UE 415 may distribute (e.g., split) the uplink shared channel power (e.g., PUSCH power) across antenna ports 0, 1, 2, and 3 based on γᵢ for each i as per 1/2, 1/6, 1/6, and 1/6, respectively.

Further, UE 415 may distribute the uplink shared channel power (e.g., PUSCH power) allocated to each antenna across one or more layers based on the ratio between |c_{i,0}|² and |c_{i,1}|².

In some cases, the threshold γ_{i,thr} may be port-common, or port-specific, and may be signaled by UE as capability (e.g., at 420). The threshold γ_{i,thr} may be interpreted as a highest ratio for an antenna port i if the uplink transmission (e.g., PUSCH) is transmitted at (additionally, or alternatively, under) max power. Further, for each of the one or more antenna ports, the one or more power ratios across one or more transmission layers may be based on amplitudes of the one or more transmission layers. That is, for each antenna port of UE 415, the one or more power splitting ratio across layers may be based on the one or more amplitudes of the corresponding layers.

In some aspects, the power headroom report that includes at least one of the one or more parameters may be a per antenna port power headroom report for the one or more antenna ports.

For frequency selective precoding, in some aspects, UE 415 with a power class of 26 dBm may include 4 Tx with four PAs corresponding to 23 dBm each. UE 415 may report {0.5, 0.5, 0.5, 0.5} as the threshold for each antenna port of the 4 Tx (e.g., 23 dBm may correspond to a power value that is half that of 26 dBm). Based on uplink power control (e.g., open loop, closed loop), UE 415 may calculate the actual uplink transmission (e.g., PUSCH) power of 24.5 dBm, while P_{C,max}=26 dBm. UE 415 may determine a power scaling factor s=1. If network node 405 transmits control signaling at 425 indicating a TPMI of, as shown in Equation 25:

$$[ \begin{matrix}{c}_{0 , 0 , k} \cdot {e}^{j {θ}_{0 , 0 , k}} & {c}_{0 , 1 , k} \cdot {e}^{j {θ}_{0 , 1 , k}} \\ {c}_{1 , 0 , k} \cdot {e}^{j {θ}_{1 , 0 , k}} & {c}_{1 , 1 , k} \cdot {e}^{j {θ}_{1 , 1 , k}} \\ {c}_{2 , 0 , k} \cdot {e}^{j {θ}_{2 , 0 , k}} & {c}_{2 , 1 , k} \cdot {e}^{j {θ}_{2 , 1 , k}} \\ {c}_{3 , 0 , k} \cdot {e}^{j {θ}_{3 , 0 , k}} & {c}_{3 , 1 , k} \cdot {e}^{j {θ}_{3 , 1 , k}}\end{matrix} ] \qquad ( 25 )$$

where, as shown in Equation 26:

$$[ \begin{matrix}{\sum }_{k = 0}^{{N}_{SB} - 1} {\vert {c}_{0 , 0 , k} \vert}^{2} + {\vert {c}_{0 , 1 , k} \vert}^{2} \\ {\sum }_{k = 0}^{{N}_{SB} - 1} {\vert {c}_{1 , 0 , k} \vert}^{2} + {\vert {c}_{1 , 1 , k} \vert}^{2} \\ {\sum }_{k = 0}^{{N}_{SB} - 1} {\vert {c}_{2 , 0 , k} \vert}^{2} + {\vert {c}_{2 , 1 , k} \vert}^{2} \\ {\sum }_{k = 0}^{{N}_{SB} - 1} {\vert {c}_{3 , 0 , k} \vert}^{2} + {\vert {c}_{3 , 1 , k} \vert}^{2}\end{matrix} ] = [ \begin{matrix}1 \\ 0.25 \\ 0.25 \\ 0.25\end{matrix} ] \qquad ( 26 )$$

UE 415 may calculate, as shown in Equation 27:

$$[ \begin{matrix}{γ}_{0} \\ {γ}_{1} \\ {γ}_{2} \\ {γ}_{3}\end{matrix} ] = [ \begin{matrix}4 / 7 \\ 1 / 7 \\ 1 / 7 \\ 1 / 7\end{matrix} ] \qquad ( 27 )$$

as each ratio corresponding to each antenna port. UE 415 may compare γᵢ with the adjusted (e.g., scaled) threshold. That is,

$${\hat{γ}}_{i , thr} = \frac{0.5}{\frac{{P}_{PUSCH , linear}}{{P}_{C , max , linear}}} \approx 0.7 .$$

UE 415 may determine that the power splitting ratio γ₀=0.5 and remaining power may be P_{PUSCH,linear}=1−0.5 while

$${\hat{γ}}_{1} = {\hat{γ}}_{2} = {\hat{γ}}_{3} = \frac{1}{7} * \frac{( 1 - 0.5 )}{1 - \frac{4}{7}} = 1 / 6 \approx 0.167 .$$

Thus, UE 415 may distribute (e.g., split) the uplink shared channel power (e.g., PUSCH power) across antenna ports 0, 1, 2, and 3 based on γᵢ for each i as per 1/2, 1/6, 1/6, and 1/6, respectively.

Further, UE 415 may distribute the uplink shared channel power (e.g., PUSCH power) allocated to each antenna across one or more layers based on the ratio between |c_{i,0}|² and |c_{i,1}|².

For frequency selective precoding, in some other aspects, UE 415 with a power class of 26 dBm may include 4 Tx with four PAs corresponding to 23 dBm each. UE 415 may report {0.5, 0.5, 0.5, 0.5} as the threshold for each antenna port of the 4 Tx (e.g., 23 dBm may correspond to a power value that is half that of 26 dBm). Based on uplink power control (e.g., open loop, closed loop), UE 415 may calculate the actual uplink transmission (e.g., PUSCH) power of 24.5 dBm, while P_{C,max}=26 dBm. UE 415 may determine a power scaling factor s=1. For uplink TPMI with FD compression, if network node 405 (e.g., the network) configures TPMI on subband k as the following (Equation 28):

$$[ \begin{matrix}{c}_{0 , 0 , k} \cdot {e}^{j {θ}_{0 , 0 , k}} \cdot {f}_{m ( 0 , 0 )} [ k ] & {c}_{0 , 1 , k} \cdot {e}^{j {θ}_{0 , 1 , k}} \cdot {f}_{m ( 0 , 1 )} [ k ] \\ {c}_{1 , 0 , k} \cdot {e}^{j {θ}_{1 , 0 , k}} \cdot {f}_{m ( 1 , 0 )} [ k ] & {c}_{1 , 1 , k} \cdot {e}^{j {θ}_{1 , 1 , k}} \cdot {f}_{m ( 1 , 1 )} [ k ] \\ {c}_{2 , 0 , k} \cdot {e}^{j {θ}_{2 , 0 , k}} \cdot {f}_{m ( 2 , 0 )} [ k ] & {c}_{2 , 1 , k} \cdot {e}^{j {θ}_{2 , 1 , k}} \cdot {f}_{m ( 2 , 1 )} [ k ] \\ {c}_{3 , 0 , k} \cdot {e}^{j {θ}_{3 , 0 , k}} \cdot {f}_{m ( 3 , 0 )} [ k ] & {c}_{3 , 1 , k} \cdot {e}^{j {θ}_{3 , 1 , k}} \cdot {f}_{m ( 3 , 1 )} [ k ]\end{matrix} ] \qquad ( 28 )$$

where, as shown in Equation 29:

$$[ \begin{matrix}{\sum }_{k = 0}^{{N}_{SB} - 1} {\vert {c}_{0 , 0} \cdot {f}_{m ( 0 , 0 )} [ k ] \vert}^{2} + {\vert {c}_{0 , 1} \cdot {f}_{m ( 0 , 1 )} [ k ] \vert}^{2} \\ {\sum }_{k = 0}^{{N}_{SB} - 1} {\vert {c}_{1 , 0} \cdot {f}_{m ( 1 , 0 )} [ k ] \vert}^{2} + {\vert {c}_{1 , 1} \cdot {f}_{m ( 1 , 1 )} [ k ] \vert}^{2} \\ {\sum }_{k = 0}^{{N}_{SB} - 1} {\vert {c}_{2 , 0} \cdot {f}_{m ( 2 , 0 )} [ k ] \vert}^{2} + {\vert {c}_{2 , 1} \cdot {f}_{m ( 2 , 1 )} [ k ] \vert}^{2} \\ {\sum }_{k = 0}^{{N}_{SB} - 1} {\vert {c}_{3 , 0} \cdot {f}_{m ( 3 , 0 )} [ k ] \vert}^{2} + {\vert {c}_{3 , 1} \cdot {f}_{m ( 3 , 1 )} [ k ] \vert}^{2}\end{matrix} ] = [ \begin{matrix}1 \\ 0.25 \\ 0.25 \\ 0.25\end{matrix} ] \qquad ( 29 )$$

where f_{m(i,v)}[k] may be the k-th entry of the FD basis applied to port i and layer v. UE 415 may calculate, as shown in Equation 30:

$$[ \begin{matrix}{γ}_{0} \\ {γ}_{1} \\ {γ}_{2} \\ {γ}_{3}\end{matrix} ] = [ \begin{matrix}4 / 7 \\ 1 / 7 \\ 1 / 7 \\ 1 / 7\end{matrix} ] \qquad ( 30 )$$

as each ratio corresponding to each antenna port. UE 415 may compare γᵢ with the adjusted (e.g., scaled) threshold. That is,

$${\hat{γ}}_{i , thr} = \frac{0.5}{\frac{{P}_{PUSCH , linear}}{{P}_{C , max , linear}}} \approx 0.7 .$$

UE 415 may determine that the power splitting ratio γ₀=0.5 and remaining power may be P_{PUSCH,linear}=1−0.5 while

$${\hat{γ}}_{1} = {\hat{γ}}_{2} = {\hat{γ}}_{3} = \frac{1}{7} * \frac{( 1 - 0.5 )}{1 - \frac{4}{7}} = 1 / 6 \approx 0.167 .$$

Thus, UE 415 may distribute (e.g., split) the uplink shared channel power (e.g., PUSCH power) across antenna ports 0, 1, 2, and 3 based on γᵢ for each i as per 1/2, 1/6, 1/6, and 1/6, respectively.

Further, UE 415 may distribute the uplink shared channel power (e.g., PUSCH power) allocated to each antenna across one or more layers based on the ratio between |c_{i,0}|² and |c_{i,1}|².

At 440, UE 415 may transmit, to network node 405, an uplink transmission (e.g., the uplink shared channel) using the one or more antenna ports in accordance with the modified (e.g., scaled, split, or both) transmission power.

By scaling and splitting power for uplink transmissions (e.g., PUSCH), UE 415 may be able to correctly allocate power to antenna ports (e.g., so as to not over-allocate power to PAs) for transmission in high-resolution TPMI scenarios.

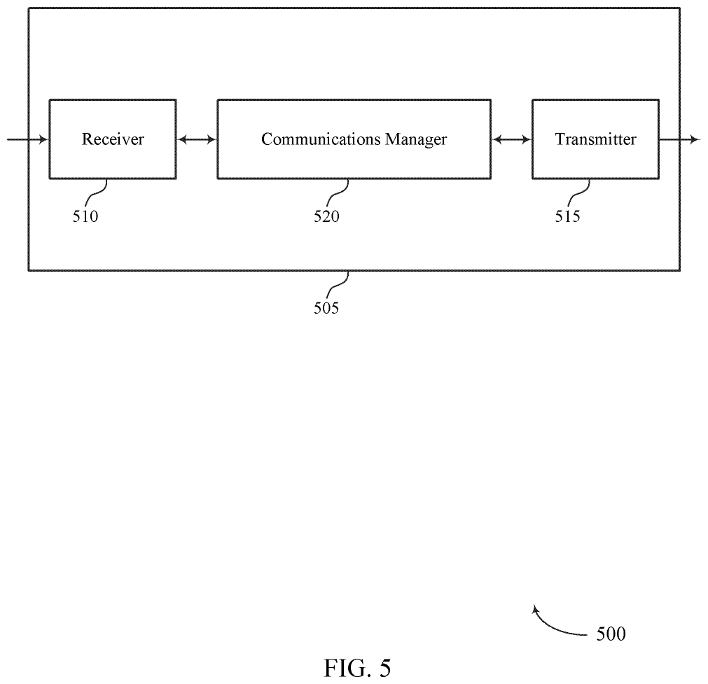

FIG. 5 shows a block diagram 500 of a device 505 that supports power scaling and splitting for uplink high resolution TPMI in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to power scaling and splitting for uplink high resolution TPMI). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to power scaling and splitting for uplink high resolution TPMI). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of power scaling and splitting for uplink high resolution TPMI as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at network node (e.g., a UE) in accordance with examples as disclosed herein. For example, the communications manager 520 may be configured as or otherwise support a means for receiving, from a second network node, information indicative of a precoder to be applied to an uplink shared channel transmission. The communications manager 520 may be configured as or otherwise support a means for modifying a first transmission power resulting in a second transmission power, where the first transmission power is for transmission of the uplink shared channel transmission, and where the first network node modifies the first transmission power based on one or more coefficients associated with the precoder. The communications manager 520 may be configured as or otherwise support a means for transmitting, to the second network node, the uplink shared channel transmission using one or more antenna ports in accordance with the second transmission power.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for reduced processing, reduced power consumption, and more efficient utilization of communication resources.

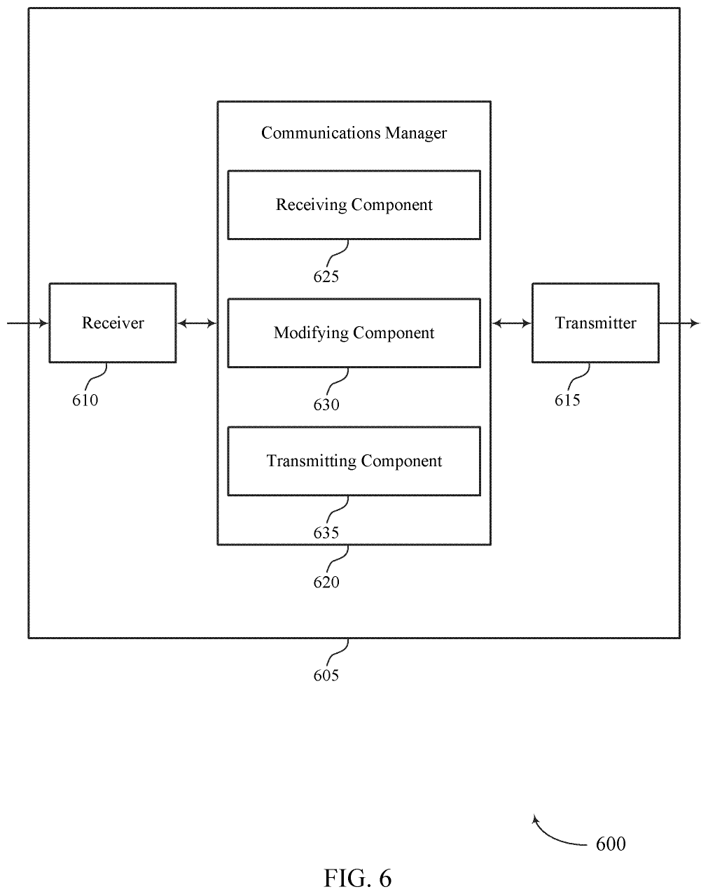

FIG. 6 shows a block diagram 600 of a device 605 that supports power scaling and splitting for uplink high resolution TPMI in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to power scaling and splitting for uplink high resolution TPMI). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to power scaling and splitting for uplink high resolution TPMI). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of power scaling and splitting for uplink high resolution TPMI as described herein. For example, the communications manager 620 may include a receiving component 625, a modifying component 630, a transmitting component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication network node (e.g., a UE) in accordance with examples as disclosed herein. The receiving component 625 may be configured as or otherwise support a means for receiving, from a second network node, information indicative of a precoder to be applied to an uplink shared channel transmission. The modifying component 630 may be configured as or otherwise support a means for modifying a first transmission power resulting in a second transmission power, where the first transmission power is for transmission of the uplink shared channel transmission, and where the first network node modifies the first transmission power based on one or more coefficients associated with the precoder. The transmitting component 635 may be configured as or otherwise support a means for transmitting, to the second network node, the uplink shared channel transmission using one or more antenna ports in accordance with the second transmission power.

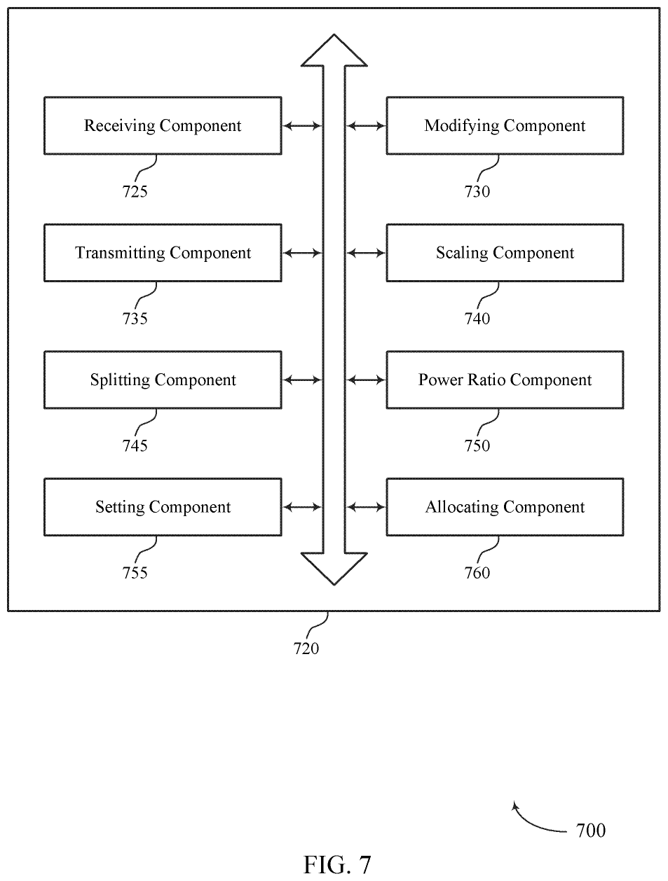

FIG. 7 shows a block diagram 700 of a communications manager 720 that supports power scaling and splitting for uplink high resolution TPMI in accordance with one or more aspects of the present disclosure. The communications manager 720 may be an example of aspects of a communications manager 520, a communications manager 620, or both, as described herein. The communications manager 720, or various components thereof, may be an example of means for performing various aspects of power scaling and splitting for uplink high resolution TPMI as described herein. For example, the communications manager 720 may include a receiving component 725, a modifying component 730, a transmitting component 735, a scaling component 740, a splitting component 745, a power ratio component 750, a setting component 755, an allocating component 760, or any combination thereof. Each of these components may communicate, directly or indirectly, with one another (e.g., via one or more buses).

The communications manager 720 may support wireless communication network node (e.g., a UE) in accordance with examples as disclosed herein. The receiving component 725 may be configured as or otherwise support a means for receiving, from a second network node, information indicative of a precoder to be applied to an uplink shared channel transmission. The modifying component 730 may be configured as or otherwise support a means for modifying a first transmission power resulting in a second transmission power, where the first transmission power is for transmission of the uplink shared channel transmission, and where the first network node modifies the first transmission power based on one or more coefficients associated with the precoder. The transmitting component 735 may be configured as or otherwise support a means for transmitting, to the second network node, the uplink shared channel transmission using one or more antenna ports in accordance with the second transmission power.

In some examples, to support modifying the first transmission power, the scaling component 740 may be configured as or otherwise support a means for scaling the first transmission power by a power scaling factor resulting in the second transmission power, where the power scaling factor is based on one or more coefficients associated with the precoder. In some examples, to support modifying the first transmission power, the splitting component 745 may be configured as or otherwise support a means for splitting the second transmission power across one or more antenna ports.

In some examples, the power scaling factor is based on a comparison of a ratio to a threshold. In some examples, the ratio corresponds to one of the one or more coefficients divided by a sum of the one or more coefficients.

In some examples, the power scaling factor is based on power headroom information corresponding to an amount of available transmission power.

In some examples, the power headroom information includes respective power headroom information for each respective antenna port of the one or more antenna ports.

In some examples, the power scaling factor is a first value if the ratio is less than or equal to the threshold, or a second value if the ratio is greater than or equal to the threshold.

In some examples, each antenna port of the one or more antenna ports corresponds to a respective port-specific threshold.

In some examples, the threshold corresponds to each antenna port of one or more antenna ports.

In some examples, the transmitting component 735 may be configured as or otherwise support a means for transmitting, to the second network node, information indicative of the threshold.

In some examples, to support splitting the second transmission power across the one or more antenna ports, the splitting component 745 may be configured as or otherwise support a means for splitting the second transmission power based on the ratio.

In some examples, the transmitting component 735 may be configured as or otherwise support a means for transmitting a message indicative of a respective threshold for each port of the one or more antenna ports, where the power scaling factor is based on a comparison of a ratio to one or more of the respective thresholds, and where the ratio corresponds to one of the one or more coefficients divided by a sum of the one or more coefficient.

In some examples, to support modifying the first transmission power, the scaling component 740 may be configured as or otherwise support a means for scaling the first transmission power by a power scaling factor resulting in a second transmission power. In some examples, to support modifying the first transmission power, the splitting component 745 may be configured as or otherwise support a means for splitting the second transmission power across one or more antenna ports based on one or more coefficients associated with the precoder.

In some examples, to support splitting the second transmission power, the power ratio component 750 may be configured as or otherwise support a means for determining one or more power ratios corresponding to each of the one or more antenna ports based on the one or more coefficients associated with precoder, where a first portion of the one or more antenna ports that correspond to power ratios exceeding a threshold include a first set of antenna ports, and a second portion of the one or more antenna ports that correspond to power ratios not exceeding the threshold include a second set of antenna ports.

In some examples, to support splitting the second transmission power, the setting component 755 may be configured as or otherwise support a means for setting respective power ratios for the first set of antenna ports equal to the threshold based on the power ratios exceeding the threshold prior to being set equal to the threshold. In some examples, to support splitting the second transmission power, the allocating component 760 may be configured as or otherwise support a means for allocating the second transmission power across the first set of antenna ports and the second set of antenna ports based on the one or more power ratios.

In some examples, to support determining the one or more power ratios, the power ratio component 750 may be configured as or otherwise support a means for determining the one or more power ratios, where for each of the one or more antenna ports, the one or more power ratios across one or more transmission layers are based on amplitudes of the one or more transmission layers.

In some examples, each antenna port of the one or more antenna ports corresponds to a respective port-specific threshold.

In some examples, the threshold corresponds to each antenna port one or more antenna ports.

In some examples, the transmitting component 735 may be configured as or otherwise support a means for transmitting, to the second network node, information indicative of the threshold.

In some examples, the transmitting component 735 may be configured as or otherwise support a means for transmitting a message indicative of a respective threshold for each port of the one or more antenna ports.

In some examples, to support splitting the second transmission power, the splitting component 745 may be configured as or otherwise support a means for splitting the second transmission power based on the first transmission power and power headroom information corresponding to an amount of available transmission power.

In some examples, the power headroom information includes respective power headroom information for each respective antenna port of the one or more antenna ports.

In some examples, to support scaling the first transmission power by the power scaling factor, the scaling component 740 may be configured as or otherwise support a means for scaling the first transmission power by the power scaling factor that is defined as a quantity of non-zero antenna ports divided by a quantity of sounding reference signal antenna ports.

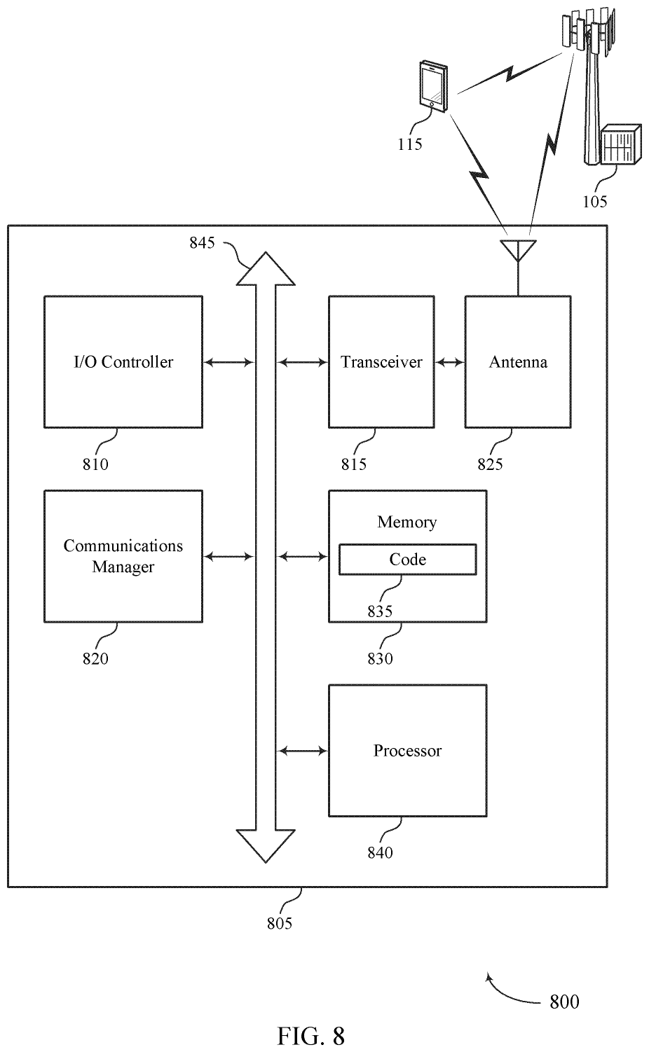

FIG. 8 shows a diagram of a system 800 including a device 805 that supports power scaling and splitting for uplink high resolution TPMI in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting power scaling and splitting for uplink high resolution TPMI). For example, the device 805 or a component of the device 805 may include a processor 840 and memory 830 coupled to the processor 840, the processor 840 and memory 830 configured to perform various functions described herein.

The communications manager 820 may support wireless communication network node (e.g., a UE) in accordance with examples as disclosed herein. For example, the communications manager 820 may be configured as or otherwise support a means for receiving, from a second network node, information indicative of a precoder to be applied to an uplink shared channel transmission. The communications manager 820 may be configured as or otherwise support a means for modifying a first transmission power resulting in a second transmission power, where the first transmission power is for transmission of the uplink shared channel transmission, and where the first network node modifies the first transmission power based on one or more coefficients associated with the precoder. The communications manager 820 may be configured as or otherwise support a means for transmitting, to the second network node, the uplink shared channel transmission using one or more antenna ports in accordance with the second transmission power.

By including or configuring the communications manager 820 in accordance with examples as described herein, the device 805 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of power scaling and splitting for uplink high resolution TPMI as described herein, or the processor 840 and the memory 830 may be otherwise configured to perform or support such operations.

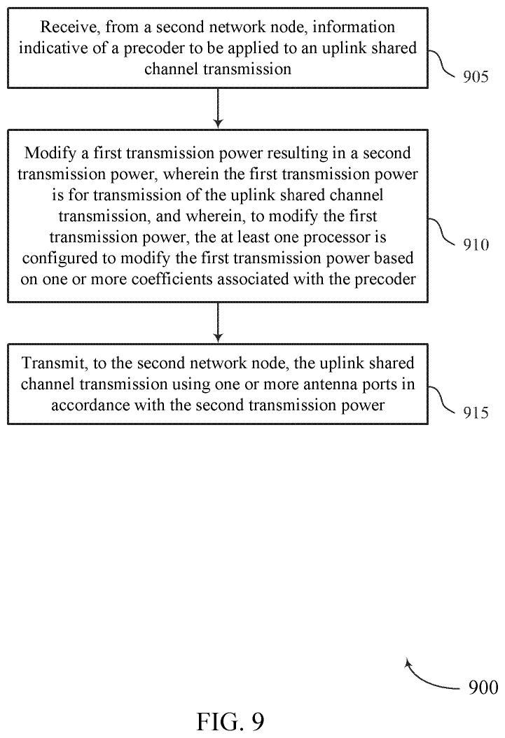

FIG. 9 shows a flowchart illustrating a method 900 that supports power scaling and splitting for uplink high resolution TPMI in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include receiving, from a second network node, information indicative of a precoder to be applied to an uplink shared channel transmission. The operations of 905 may be performed in accordance with examples as disclosed herein. In some examples, aspects of the operations of 905 may be performed by a receiving component 725 as described with reference to FIG. 7.

At 910, the method may include modifying a first transmission power resulting in a second transmission power, where the first transmission power is for transmission of the uplink shared channel transmission, and where the first network node modifies the first transmission power based on one or more coefficients associated with the precoder. The operations of 910 may be performed in accordance with examples as disclosed herein. In some examples, aspects of the operations of 910 may be performed by a modifying component 730 as described with reference to FIG. 7.

At 915, the method may include transmitting, to the second network node, the uplink shared channel transmission using one or more antenna ports in accordance with the second transmission power. The operations of 915 may be performed in accordance with examples as disclosed herein. In some examples, aspects of the operations of 915 may be performed by a transmitting component 735 as described with reference to FIG. 7.

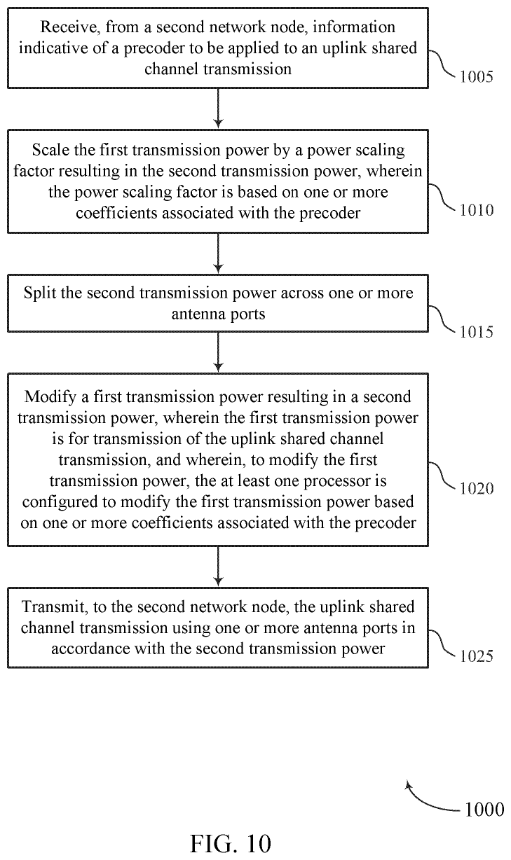

FIG. 10 shows a flowchart illustrating a method 1000 that supports power scaling and splitting for uplink high resolution TPMI in accordance with one or more aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1005, the method may include receiving, from a second network node, information indicative of a precoder to be applied to an uplink shared channel transmission. The operations of 1005 may be performed in accordance with examples as disclosed herein. In some examples, aspects of the operations of 1005 may be performed by a receiving component 725 as described with reference to FIG. 7.

At 1010, the method may include scaling the first transmission power by a power scaling factor resulting in the second transmission power, where the power scaling factor is based on one or more coefficients associated with the precoder. The operations of 1010 may be performed in accordance with examples as disclosed herein. In some examples, aspects of the operations of 1010 may be performed by a scaling component 740 as described with reference to FIG. 7.

At 1015, the method may include splitting the second transmission power across one or more antenna ports. The operations of 1015 may be performed in accordance with examples as disclosed herein. In some examples, aspects of the operations of 1015 may be performed by a splitting component 745 as described with reference to FIG. 7.

At 1020, the method may include modifying a first transmission power resulting in a second transmission power, where the first transmission power is for transmission of the uplink shared channel transmission, and where the first network node modifies the first transmission power based on one or more coefficients associated with the precoder. The operations of 1020 may be performed in accordance with examples as disclosed herein. In some examples, aspects of the operations of 1020 may be performed by a modifying component 730 as described with reference to FIG. 7.

At 1025, the method may include transmitting, to the second network node, the uplink shared channel transmission using one or more antenna ports in accordance with the second transmission power. The operations of 1025 may be performed in accordance with examples as disclosed herein. In some examples, aspects of the operations of 1025 may be performed by a transmitting component 735 as described with reference to FIG. 7.

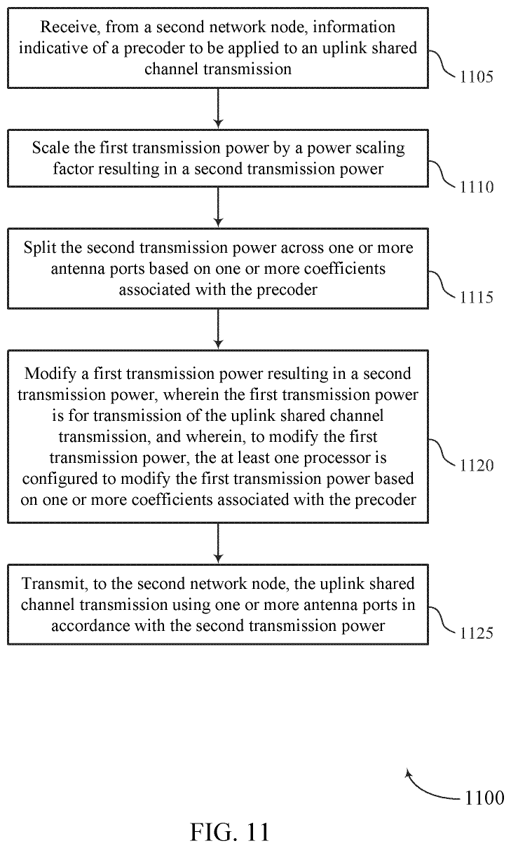

FIG. 11 shows a flowchart illustrating a method 1100 that supports power scaling and splitting for uplink high resolution TPMI in accordance with one or more aspects of the present disclosure. The operations of the method 1100 may be implemented by a UE or its components as described herein. For example, the operations of the method 1100 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1105, the method may include receiving, from a second network node, information indicative of a precoder to be applied to an uplink shared channel transmission. The operations of 1105 may be performed in accordance with examples as disclosed herein. In some examples, aspects of the operations of 1105 may be performed by a receiving component 725 as described with reference to FIG. 7.

At 1110, the method may include scaling the first transmission power by a power scaling factor resulting in a second transmission power. The operations of 1110 may be performed in accordance with examples as disclosed herein. In some examples, aspects of the operations of 1110 may be performed by a scaling component 740 as described with reference to FIG. 7.

At 1115, the method may include splitting the second transmission power across one or more antenna ports based on one or more coefficients associated with the precoder. The operations of 1115 may be performed in accordance with examples as disclosed herein. In some examples, aspects of the operations of 1115 may be performed by a splitting component 745 as described with reference to FIG. 7.

At 1120, the method may include modifying a first transmission power resulting in a second transmission power, where the first transmission power is for transmission of the uplink shared channel transmission, and where the first network node modifies the first transmission power based on one or more coefficients associated with the precoder. The operations of 1120 may be performed in accordance with examples as disclosed herein. In some examples, aspects of the operations of 1120 may be performed by a modifying component 730 as described with reference to FIG. 7.

At 1125, the method may include transmitting, to the second network node, the uplink shared channel transmission using one or more antenna ports in accordance with the second transmission power. The operations of 1125 may be performed in accordance with examples as disclosed herein. In some examples, aspects of the operations of 1125 may be performed by a transmitting component 735 as described with reference to FIG. 7.

The following provides an overview of aspects of the present disclosure:

Aspect 1: A method for wireless communication at a first network node, comprising: receiving, from a second network node, information indicative of a precoder to be applied to an uplink shared channel transmission; modifying a first transmission power resulting in a second transmission power, wherein the first transmission power is for transmission of the uplink shared channel transmission, and wherein the first network node modifies the first transmission power based on one or more coefficients associated with the precoder; and transmitting, to the second network node, the uplink shared channel transmission using one or more antenna ports in accordance with the second transmission power.

Aspect 2: The method of aspect 1, wherein modifying the first transmission power further comprises: scaling the first transmission power by a power scaling factor resulting in the second transmission power, wherein the power scaling factor is based on one or more coefficients associated with the precoder; and splitting the second transmission power across one or more antenna ports.

Aspect 3: The method of aspect 2, wherein the power scaling factor is based on a comparison of a ratio to a threshold, the ratio corresponds to one of the one or more coefficients divided by a sum of the one or more coefficients.

Aspect 4: The method of aspect 3, wherein the power scaling factor is based on power headroom information corresponding to an amount of available transmission power.

Aspect 5: The method of aspect 4, wherein the power headroom information includes respective power headroom information for each respective antenna port of the one or more antenna ports.

Aspect 6: The method of any of aspects 3 through 5, wherein the power scaling factor is a first value if the ratio is less than or equal to the threshold, or a second value if the ratio is greater than or equal to the threshold.

Aspect 7: The method of any of aspects 3 through 6, wherein each antenna port of the one or more antenna ports corresponds to a respective port-specific threshold.

Aspect 8: The method of any of aspects 3 through 7, wherein the threshold corresponds to each antenna port of one or more antenna ports.

Aspect 9: The method of any of aspects 3 through 8, further comprising: transmitting, to the second network node, information indicative of the threshold.

Aspect 10: The method of any of aspects 3 through 9, wherein splitting the second transmission power across the one or more antenna ports further comprises: splitting the second transmission power based on the ratio.

Aspect 11: The method of any of aspects 2 through 10, further comprising: transmitting a message indicative of a respective threshold for each port of the one or more antenna ports, wherein the power scaling factor is based on a comparison of a ratio to one or more of the respective thresholds, and wherein the ratio corresponds to one of the one or more coefficients divided by a sum of the one or more coefficient.

Aspect 12: The method of any of aspects 1 through 11, wherein modifying the first transmission power further comprises: scaling the first transmission power by a power scaling factor resulting in a second transmission power; and splitting the second transmission power across one or more antenna ports based on one or more coefficients associated with the precoder.

Aspect 13: The method of aspect 12, wherein splitting the second transmission power further comprises: determining one or more power ratios corresponding to each of the one or more antenna ports based on the one or more coefficients associated with precoder, wherein a first portion of the one or more antenna ports that correspond to power ratios exceeding a threshold comprise a first set of antenna ports, and a second portion of the one or more antenna ports that correspond to power ratios not exceeding the threshold comprise a second set of antenna ports.

Aspect 14: The method of aspect 13, wherein splitting the second transmission power further comprises: setting respective power ratios for the first set of antenna ports equal to the threshold based on the power ratios exceeding the threshold prior to being set equal to the threshold; and allocating the second transmission power across the first set of antenna ports and the second set of antenna ports based on the one or more power ratios.

Aspect 15: The method of any of aspects 13 through 14, wherein determining the one or more power ratios further comprises: determining the one or more power ratios, wherein for each of the one or more antenna ports, the one or more power ratios across one or more transmission layers are based on amplitudes of the one or more transmission layers.

Aspect 16: The method of any of aspects 13 through 15, wherein each antenna port of the one or more antenna ports corresponds to a respective port-specific threshold.

Aspect 17: The method of any of aspects 13 through 16, wherein the threshold corresponds to each antenna port one or more antenna ports.

Aspect 18: The method of any of aspects 13 through 17, further comprising: transmitting, to the second network node, information indicative of the threshold.

Aspect 19: The method of any of aspects 13 through 18, further comprising: transmitting a message indicative of a respective threshold for each port of the one or more antenna ports.

Aspect 20: The method of any of aspects 12 through 19, wherein splitting the second transmission power further comprises: splitting the second transmission power based on the first transmission power and power headroom information corresponding to an amount of available transmission power.

Aspect 21: The method of aspect 20, wherein the power headroom information includes respective power headroom information for each respective antenna port of the one or more antenna ports.

Aspect 22: The method of any of aspects 12 through 21, wherein scaling the first transmission power by the power scaling factor further comprises: scaling the first transmission power by the power scaling factor that is defined as a quantity of non-zero antenna ports divided by a quantity of sounding reference signal antenna ports.

Aspect 23: A first network node for wireless communications (e.g., an apparatus for wireless communication at a first network node), comprising a memory; and at least one processor coupled to the memory, wherein the at least one processor is configured to cause the apparatus to perform a method of any of aspects 1 through 22.

Aspect 24: An apparatus for wireless communication at a first network node, comprising at least one means for performing a method of any of aspects 1 through 22.

Aspect 25: A non-transitory computer-readable medium having code for wireless communication stored thereon that, when executed by a first network node, causes the first network node to perform a method of any of aspects 1 through 22.

The methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, the term “or” is an inclusive “or” unless limiting language is used relative to the alternatives listed. For example, reference to “X being based on A or B” shall be construed as including within its scope X being based on A, X being based on B, and X being based on A and B. In this regard, reference to “X being based on A or B” refers to “at least one of A or B” or “one or more of A or B” due to “or” being inclusive. Similarly, reference to “X being based on A, B, or C” shall be construed as including within its scope X being based on A, X being based on B, X being based on C, X being based on A and B, X being based on A and C, X being based on B and C, and X being based on A, B, and C. In this regard, reference to “X being based on A, B, or C” refers to “at least one of A, B, or C” or “one or more of A, B, or C” due to “or” being inclusive. As an example of limiting language, reference to “X being based on only one of A or B” shall be construed as including within its scope X being based on A as well as X being based on B, but not X being based on A and B. Also, as used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. Also, as used herein, the phrase “a set” shall be construed as including the possibility of a set with one member. That is, the phrase “a set” shall be construed in the same manner as “one or more” or “at least one of.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the drawings, describes example configurations and does not represent all the examples that may be implemented or that are within the scope of the claims. The term “aspect” or “example” used herein means “serving as an aspect, example, instance, or illustration,” and not “preferred” or “advantageous over other aspects.” The detailed description includes specific details for the purpose of providing an understanding of the described techniques. These techniques, however, may be practiced without these specific details. In some instances, structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A first network node for wireless communication, comprising:
a memory; and
at least one processor coupled to the memory, wherein the at least one processor is configured to:
receive, from a second network node, information indicative of a precoder to be applied to an uplink shared channel transmission;
modify a first transmission power resulting in a second transmission power, wherein the first transmission power is for transmission of the uplink shared channel transmission, and wherein, to modify the first transmission power, the at least one processor is configured to modify the first transmission power based on one or more coefficients associated with the precoder; and
transmit, to the second network node, the uplink shared channel transmission using one or more antenna ports in accordance with the second transmission power.

2. The first network node of claim 1, wherein, to modify the first transmission power, the at least one processor is configured to:
scale the first transmission power by a power scaling factor resulting in the second transmission power, wherein the power scaling factor is based on one or more coefficients associated with the precoder; and
split the second transmission power across one or more antenna ports.

3. The first network node of claim 2, wherein:
the power scaling factor is based on a comparison of a ratio to a threshold, and
the ratio corresponds to one of the one or more coefficients divided by a sum of the one or more coefficients.

4. The first network node of claim 3, wherein the power scaling factor is based on power headroom information corresponding to an amount of available transmission power.

5. The first network node of claim 4, wherein the power headroom information includes respective power headroom information for each respective antenna port of the one or more antenna ports.

6. The first network node of claim 3, wherein the power scaling factor is a first value if the ratio is less than or equal to the threshold, or a second value if the ratio is greater than or equal to the threshold.

7. The first network node of claim 3, wherein each antenna port of the one or more antenna ports corresponds to a respective port-specific threshold.

8. The first network node of claim 3, wherein the threshold corresponds to each antenna port of one or more antenna ports.

9. The first network node of claim 3, wherein the at least one processor is configured to:
transmit, to the second network node, information indicative of the threshold.

10. The first network node of claim 3, wherein, to split the second transmission power across the one or more antenna ports, the at least one processor is configured to:
split the second transmission power based on the ratio.

11. The first network node of claim 2, wherein the at least one processor is configured to:
transmit a message indicative of a respective threshold for each port of the one or more antenna ports, wherein the power scaling factor is based on a comparison of a ratio to one or more of the respective thresholds, and wherein the ratio corresponds to one of the one or more coefficients divided by a sum of the one or more coefficient.

12. The first network node of claim 1, wherein, to modify the first transmission power, the at least one processor is configured to:
scale the first transmission power by a power scaling factor resulting in a second transmission power; and
split the second transmission power across one or more antenna ports based on one or more coefficients associated with the precoder.

13. The first network node of claim 12, wherein, to split the second transmission power, the at least one processor is configured to:
determine one or more power ratios corresponding to each of the one or more antenna ports based on the one or more coefficients associated with precoder, wherein a first portion of the one or more antenna ports that correspond to power ratios exceeding a threshold comprise a first set of antenna ports, and a second portion of the one or more antenna ports that correspond to power ratios not exceeding the threshold comprise a second set of antenna ports.

14. The first network node of claim 13, wherein, to split the second transmission power, the at least one processor is configured to:
set respective power ratios for the first set of antenna ports equal to the threshold based on the power ratios exceeding the threshold prior to being set equal to the threshold; and
allocate the second transmission power across the first set of antenna ports and the second set of antenna ports based on the one or more power ratios.

15. The first network node of claim 13, wherein, to determine one or more power ratios, the at least one processor is configured to:
determine the one or more power ratios, wherein for each of the one or more antenna ports, the one or more power ratios across one or more transmission layers are based on amplitudes of the one or more transmission layers.

16. The first network node of claim 13, wherein each antenna port of the one or more antenna ports corresponds to a respective port-specific threshold.

17. The first network node of claim 13, wherein the threshold corresponds to each antenna port one or more antenna ports.

18. The first network node of claim 13, wherein the at least one processor is configured to:
transmit, to the second network node, information indicative of the threshold.

19. The first network node of claim 13, wherein the at least one processor is configured to:
transmit a message indicative of a respective threshold for each port of the one or more antenna ports.

20. The first network node of claim 12, wherein, to split the second transmission power, the at least one processor is configured to:
split the second transmission power based on the first transmission power and power headroom information corresponding to an amount of available transmission power.

21. The first network node of claim 20, wherein the power headroom information includes respective power headroom information for each respective antenna port of the one or more antenna ports.

22. The first network node of claim 12, wherein, to scale the first transmission power by the power scaling factor, the at least one processor is configured to:
scale the first transmission power by the power scaling factor that is defined as a quantity of non-zero antenna ports divided by a quantity of sounding reference signal antenna ports.

23. A method for wireless communication at a first network node, comprising:
receiving, from a second network node, information indicative of a precoder to be applied to an uplink shared channel transmission;
modifying a first transmission power resulting in a second transmission power, wherein the first transmission power is for transmission of the uplink shared channel transmission, and wherein the first network node modifies the first transmission power based on one or more coefficients associated with the precoder; and
transmitting, to the second network node, the uplink shared channel transmission using one or more antenna ports in accordance with the second transmission power.

24. The method of claim 23, wherein modifying the first transmission power further comprises:
scaling the first transmission power by a power scaling factor resulting in the second transmission power, wherein the power scaling factor is based on one or more coefficients associated with the precoder; and
splitting the second transmission power across one or more antenna ports.

25. The method of claim 24, further comprising:
transmitting a message indicative of a respective threshold for each port of the one or more antenna ports, wherein the power scaling factor is based on a comparison of a ratio to one or more of the respective thresholds, and wherein the ratio corresponds to one of the one or more coefficients divided by a sum of the one or more coefficient.

26. The method of claim 23, wherein modifying the first transmission power further comprises:
scaling the first transmission power by a power scaling factor resulting in a second transmission power; and
splitting the second transmission power across one or more antenna ports based on one or more coefficients associated with the precoder.

27. The method of claim 26, wherein splitting the second transmission power further comprises:
splitting the second transmission power based on the first transmission power and power headroom information corresponding to an amount of available transmission power.

28. The method of claim 26, wherein scaling the first transmission power by the power scaling factor further comprises:
scaling the first transmission power by the power scaling factor that is defined as a quantity of non-zero antenna ports divided by a quantity of sounding reference signal antenna ports.

29. An apparatus for wireless communication at a first network node, comprising:
means for receiving, from a second network node, information indicative of a precoder to be applied to an uplink shared channel transmission;
means for modifying a first transmission power resulting in a second transmission power, wherein the first transmission power is for transmission of the uplink shared channel transmission, and wherein the first network nodes modifies the first transmission power based on one or more coefficients associated with the precoder; and
means for transmitting, to the second network node, the uplink shared channel transmission using one or more antenna ports in accordance with the second transmission power.

30. A non-transitory computer-readable medium having code for wireless communication stored thereon that, when executed by a first network node, causes the first network node to:
receive, from a second network node, information indicative of a precoder to be applied to an uplink shared channel transmission;
modify a first transmission power resulting in a second transmission power, wherein the first transmission power is for transmission of the uplink shared channel transmission, and wherein the first network nodes modifies the first transmission power based on one or more coefficients associated with the precoder; and
transmit, to the second network node, the uplink shared channel transmission using one or more antenna ports in accordance with the second transmission power.
